(19) United States
(12) Patent Application Publication
(10) Pub. No.: US 2005/0267900 A1
(43) Pub. Date: Dec. 1, 2005

(54) Method and system for organizing data relating to a home

(76) Inventors: Osman Ahmed, Hawthorn Woods, IL (US); Ahsanul Karim, Chicago, IL (US); Rashid Zaman, Dhaka (BD); Sameem Samad, Buffalo Grove, IL (US)

Correspondence Address: GREER, BURNS & CRAIN, LTD., Suite 2500, Chicago, IL, 60606, US

(21) Appl. No.: 11/096,237

(22) Filed: Mar. 30, 2005

Related U.S. Application Data
(60) Provisional application No. 60/557,339, filed on Mar. 30, 2004.

(51) Int. Cl. G06F 7/00

(52) U.S. Cl. 707/100

(57) ABSTRACT

Method for collecting data relating to a household. An object model is provided including a plurality of objects representing items relating to the household. A data item is received including information relating to a section of the household, and the data item is incorporated into the object model.

### PRIORITY CLAIM

This application claims the benefit of U.S. Provisional Application Ser. No. 60/557,339, filed Mar. 30, 2004, under 35 U.S.C. §119.

### BACKGROUND OF THE INVENTION

A field of the invention is data management.

It is desired to keep track of sales, purchase, maintenance, renovation, upgrades, status, etc. relating to condition and repair of a home. However, this can be difficult to do consistently. For example, items relating to the home may originate from various sources, including documents generated during home building, home purchase, repair of components, acquisition of home-related equipment, business or legal transactions, etc.

Additionally, a homeowner is often inundated with information relating to a home from such outside parties as vendors, service providers, government agencies, etc. Such information may exist in one or more of multiple forms, such as paper documents (computer-generated, typewritten, or handwritten), online downloads, email correspondence, or others. Thus, it is difficult to collect and manage such information effectively.

Prior solutions, such as storing documents in filing cabinets, have been largely ineffective, as these are bulky and difficult to maintain. It also is difficult to retrieve or analyze home-related information efficiently. Further, in a digital age, it can be challenging to integrate information existing in digital form, including information obtained online, with documents or data normally stored in hard copy form, such as in a filing cabinet. Solving this problem simply by printing out documents and adding them to a filing cabinet provides a bulky and awkward solution.

To manage such information for managing a home more efficiently, for example, it is desired to provide a management system that enables efficient input and updating of home information, easy access to the information stored, and analysis of such information if desired. Such a system can provide a central clearinghouse of information relating to a home, which will allow one to more efficiently organize the information.

### SUMMARY OF THE INVENTION

Preferred embodiments of the present invention provide among other things a method for collecting data relating to a household. An object model is provided including a plurality of objects representing items relating to the household. A data item is received including information relating to a section of the household, and the data item is incorporated into the object model.

### BRIEF DESCRIPTION OF THE DRAWINGS

FIG. 1 shows a physical set up for a home management system, according to a preferred embodiment of the present invention;

FIG. 2 shows general components of the preferred home management system;

FIG. 3 illustrates an exemplary interface for a preferred home management system;

FIG. 4 illustrates an interface for modifying preexisting objects;

FIG. 5 shows an interface for creating new objects;

FIG. 6 illustrates a hierarchically organized portion of an object model according to a preferred embodiment of the present invention;

FIG. 7 illustrates a flow of transactional information in an exemplary object model;

FIG. 8 depicts an exemplary report menu structure according to a preferred embodiment of the present invention;

FIG. 9 illustrates an exemplary menu driven interface;

FIG. 10 illustrates an exemplary graphical interface;

FIG. 11 illustrates information flow for the preferred home management system in a real estate sales cycle;

FIG. 12 shows an exemplary business transaction model incorporating the preferred home management system;

FIG. 13 illustrates a process for automatically uploading transactional information to the preferred home management system;

FIG. 14 illustrates a partial object model including exemplary sub-objects for object Property;

FIG. 15 illustrates exemplary sub-objects of Home;

FIG. 16 illustrates sub-objects of Room;

FIG. 17 illustrates relationships between common room objects and sub-objects of Room;

FIG. 18 illustrates additional sub-objects of Interior;

FIG. 19 illustrates additional custom objects for particular rooms;

FIG. 20 illustrates exemplary sub-objects for common objects of Interior;

FIG. 21 shows additional sub-objects of Interior;

FIG. 22 illustrates exemplary sub-objects of object Exterior;

FIG. 23 illustrates additional types of sub-objects for integration into an exemplary object model;

FIG. 24 illustrates a portion of an exemplary object model including Business Card objects;

FIG. 25 illustrates a partial object model incorporating other types of card objects;

FIG. 26 illustrates additional types of card objects;

FIG. 27 shows a partial object model incorporating card objects;

FIG. 28 shows additional uses of card objects in an exemplary object model;

FIG. 29 includes sub-objects of Interior incorporated with card objects;

FIG. 30 shows links between various types of objects in an exemplary object model;

FIG. 31 depicts integration of various card objects with sub-objects of Interior;

FIG. 32 shows Mechanical sub-objects incorporated with various card objects;

FIG. 33 shows linking of card objects with additional sub-objects; and

FIG. 34 illustrates additional sub-objects linked to card objects.

### DETAILED DESCRIPTION

Preferred embodiments of the present invention provide, among other things, a system for organizing information relating to a home. Such information, for example, may be collected, generated, modified, or used as part of maintenance, renovation, and updates to a home. Such information can be stored from a time when a new home is constructed or delivered, from a time when a home changes existing ownership, or from a later time. The system potentially has a significant effect on how a home may be managed. Particularly, such a system can enable homeowners to derive various benefits from the ability to more easily store information, to update information, to analyze information, and/or access information.

An object model platform is structured to logically represent physical inter-relationships between different items relating to a household, which are acquired via an input platform. A model-based database stores collected objects of the object model platform. The database, with the object model-based information platform, preferably can propagate information throughout the platform. A user can operate an applications management platform, which allows an information processing platform to access the database and process information related to the stored objects according to the application management platform.

The information processing platform allows extraction of knowledge from the object model-based information platform, which preferably can be viewed and used for any level of the modeling hierarchy. The object model platform can support various applications within a household such as the home itself, but applications may also be extended to include people, automobile, pets, etc.

A preferred system and method includes methods for gathering object information automatically when the transaction represented by one or more objects takes place between the homeowner or user of that object and an outside party, who is providing service relating to that object. The service can be, for example, sales, purchase, obtaining information, repair, regular service, and maintenance.

The input platform, in preferred embodiments, may include an interface between a homeowner and the object model-based information platform. Alternatively or additionally, the input platform may include a communication channel with outside parties, such as vendors, service providers, government agencies, etc. that may provide information to homeowners. For example, such information may be provided when home equipment or a component is replaced, repaired, maintained, or updated. By opening up such lines of communication with outside parties, it is possible to provide relevant information to a homeowner, such as sales, status, warranty, financial incentives, or other information. Such a system thus can provide benefits to both a homeowner and outside parties. In a preferred method, the received information from the outside party is integrated into the object model-based information platform, and more preferably this integration is done automatically.

It should be noted that such a system may be used to model home-related objects besides a residential building. For example, the system may be used to model automobiles, particular goods, or even occupants of a home. However, though systems are contemplated for storing other types of information, the exemplary embodiments described herein will focus on systems and methods relating to information for a home.

Throughout the life of a home, for example, information is generated that is relevant to a home and/or what is in it. Such information may be collected by a homeowner for record keeping, and possibly organized or otherwise retained for later use (such as reviewing an insurance document or a rebate request) or analysis (such as determining the amount of money spent on a particular household component).

Other information may be generated by or in cooperation with an outside party, such as a business, government agency, etc. For example, a contractor may repair an item in the home, or the homeowner may purchase materials or equipment for improving the home. This information is often provided in paper format. Though, in some cases, some documents, such as warranty documents, for example, may be downloadable from a Web site, such information still needs to be printed out in hard copy format for storage in a typical system. If the item is retained on a homeowner's computer, multiple storage locations are created, requiring multiple sources for retrieval of such information.

Conventionally, if this information has been stored by a homeowner, it has been in the form of paper documents, which may be stored in filing systems such as filing cabinets or otherwise manually organized. However, such an organization process is quite time-consuming to maintain, and it may be difficult, if not impossible, to retrieve information efficiently, update the information, use the information (e.g., analyze it), and/or plan based on the information. Such information processing using conventional systems requires a significant amount of time, and often may not be done due to the inefficiency of current methods. This problem multiplies as time of ownership of the house by a particular occupant lengthens, as the amount of information is greatly increased, irrelevant or outdated information begins to clog up the storage system, and proper management becomes increasingly difficult.

By providing an object model-based platform for storage, collection, analysis, and/or retrieval of home-related information, additional tasks such as management, updating, sales (e.g. new home sales) or other tasks can also be made simpler, more efficient, and/or more cost-effective. In a preferred embodiment, information from outside parties can be easily integrated into the object model-based platform along with other items, and in a more preferred embodiment may be directly and automatically collected for incorporation into the object model-based platform, where the information is organized for later retrieval. Such automatic, direct collection may occur, for example, for information generated by a business when a business transaction is made. This makes it easier for the business to communicate with the homeowner, and makes it easier for the homeowner to organize the information. For future transactions, it is possible for outside parties to communicate with the homeowner by providing, for, example, information about a particular product, and such information may also be integrated into the system.

In a general sense, the information generating process and any such collection process may start with the construction of a new home, and then may continue as long as the home exists. A new home for example, generates potentially thousands of pieces of information, such the type of roof material used, floor type, wall type, types of appliances, manufacturers of the appliances, landscaping items, such as types of grass, grass seed planted, interior information, such as the layout of plumbing within the wall of the house, distribution of electrical wiring, etc.

Further, when an existing home is sold or purchased, additional information about the home is generated. This information may be added to existing information already retained (e.g., in the case of the home seller), or it may be the first information available about a home to a homeowner (e.g., for a recent home purchaser).

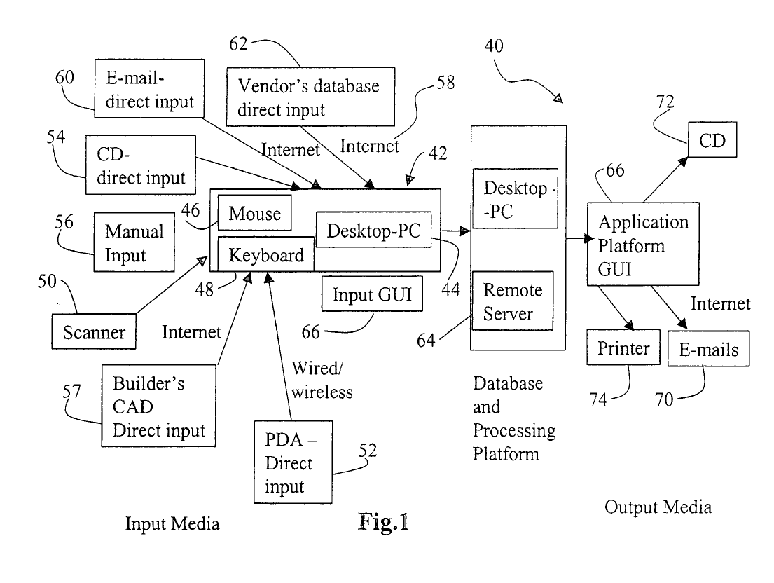

Preferred embodiments of the present invention provide a software model that generally represents a home and information relating to a home. Referring now to the drawings, FIG. 1 illustrates generally a preferred embodiment of a physical setup for implementing a home management system. The system 40 may be physically embodied in a personal computer 42 with suitable memory, storage capacity, processing, etc., as will be understood in the art. The personal computer 42 preferably further includes a monitor 44, one or more input devices, such as a keyboard 46, mouse 48, scanner 50, PDA 52, CD 54, or other manual input 56, either by the user or by an outside party, such as a builder 57, and a network connection 58 for communication over a network (such as the Internet) with an outside party. The network connection 58 may allow, for example, interface with email 60, or an outside database 62. The system may be stored on the personal computer 42, may be a machine-readable media, and/or may be embodied in a propagated signal over the network connection. The home management system 40 may be provided through a desktop program and/or via a Web-based program. The system 40 may generally include a database and processing platform 64, an input GUI 66, (including e.g., the keyboard 46 and the mouse 48) and an application platform GUI 68. The system 40 may provide output via internet 70, media 72, a printer 74, etc.

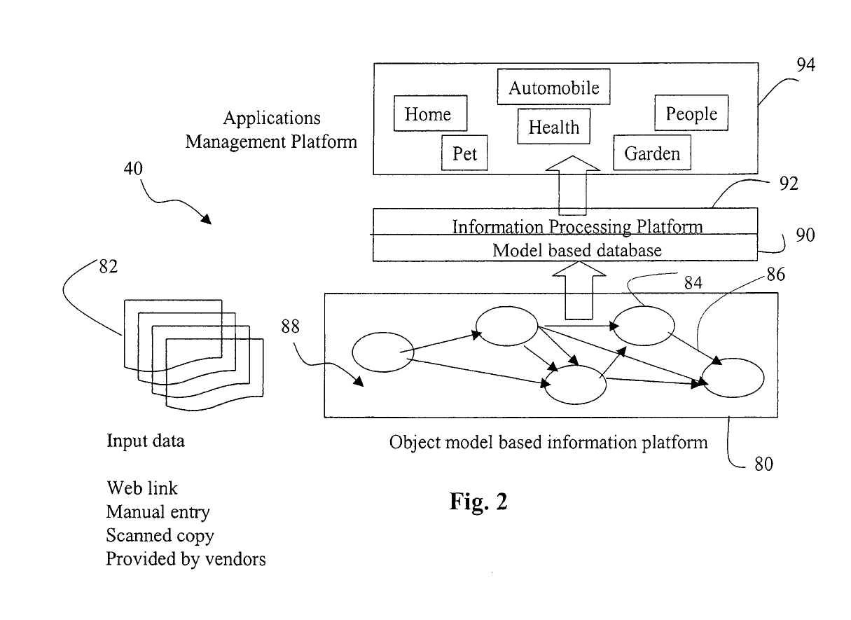

FIG. 2 shows a general view of the home management system 40. The system 40 includes an object model-based information platform 80, which interacts with an input data platform 82 to organize the input data. In this way, a data item received by the object model-based information platform 80 is incorporated into the object model-based information platform. Generally, the object model-based information platform 80 includes a plurality of objects 84, which are logically linked to represent physical linking of items. The objects 84 preferably are pre-linked within the object model-based information platform 80, though it is also preferred that a user be able to customize additional objects and/or links.

As will be understood by those of ordinary skill in the art, the object model-based information platform 80 may be implemented via object modeling. Object modeling may be used, for example, to define and capture a physical relationship between objects, events, and processes in the object model-based information platform 80. As a nonlimiting example, as appliances in a kitchen are generally located in a space called “kitchen”, activities relating to the kitchen appliance may be captured in objects 84 of the object model-based information platform 80 relating to an object Kitchen. Such objects 84 may be hierarchical and may have multiple relationships.

As another example, an oven may be described as having several attributes, such as warranty documentation, cost data, service history, etc. An Oven object may then become a sub-object (child) of a higher-level group name Kitchen (parent) as well as of another group name Appliances. Similarly, object Kitchen may belong to a higher-level object Rooms, and Rooms may in turn belong to a super-level object named Interior, which finally, may belong to a topmost object named Home. By providing the object model-based information platform 80 having a hierarchical group of links 86 among the objects 84, to capture a transaction or event in a lower level, such as buying a water filter for a refrigerator, this transaction may be propagated throughout the hierarchy, thus updating all of the information in a home linked to that object 84. Thus, information possibly influenced by the purchase of a water filter can be updated by updating objects 84 relating to the new water filter purchase.

Via the input data platform 82, information and input data can be added and/or edited by a user. The input data platform 82 preferably includes an interface between an object model 88 and the homeowner for allowing a homeowner (generally used herein to refer to a user of the system 40) to provide additions or modifications to the objects 86 in the object model. Additionally, as shown in FIG. 1, the system 40 includes an interface, which may be direct or over a network, between the object model 88 and an outside party for providing input information and integrating the information into the object model. Outside parties may include, for example, vendors, merchandise information services, etc.

A model-based database 90 includes stored objects representing information relating to the home, and executes according to the object model-based information platform 84. As used herein, a “home” is intended to be synonymous with a household or dwelling, and is intended to encompass a residential building, surrounding area, and items or people within the building, as well as outside items that may be related to the building, such as surrounding entities or businesses. The object model-based information platform 80 disseminates and utilizes information throughout the platform. Data thus propagates through stored objects in the model-based database 90.

An information processing platform 92 processes information by accessing and processing one or more objects stored in the model-based database 90. Such processing may include, for example, generation of reports, relationships, time, etc., and is performed in response to an applications management platform 94. The applications management platform 94 provides an interface for a user to obtain or derive a particular output based on information stored in the model-based database 90.

Within the overall home management system 40, the object model-based information platform 80 organizes data relating to a home. For example, an overall home management system 40 may include sub-categories such as real estate property, pets, people, automobile, garden, and health (e.g., information relating to health of home occupants), and each of these may include still lower level categories. Additionally, information organized may be related to new construction, an existing market, or both. The information may be generic, in that it is common to different homes, making adding or modifying information easier, and/or may be custom information.

The input data platform 82 allows a user to input a data item relating to the home for organizing by the object model-based information platform 80. Input may be via one or more of the input devices 54, 56, 46, 48, 50, described above, and may be direct or via a network, including but not limited to the Internet. The input data platform 82 preferably includes an interface, such as the input GUI 66, which may be graphically-based and/or menu-based.

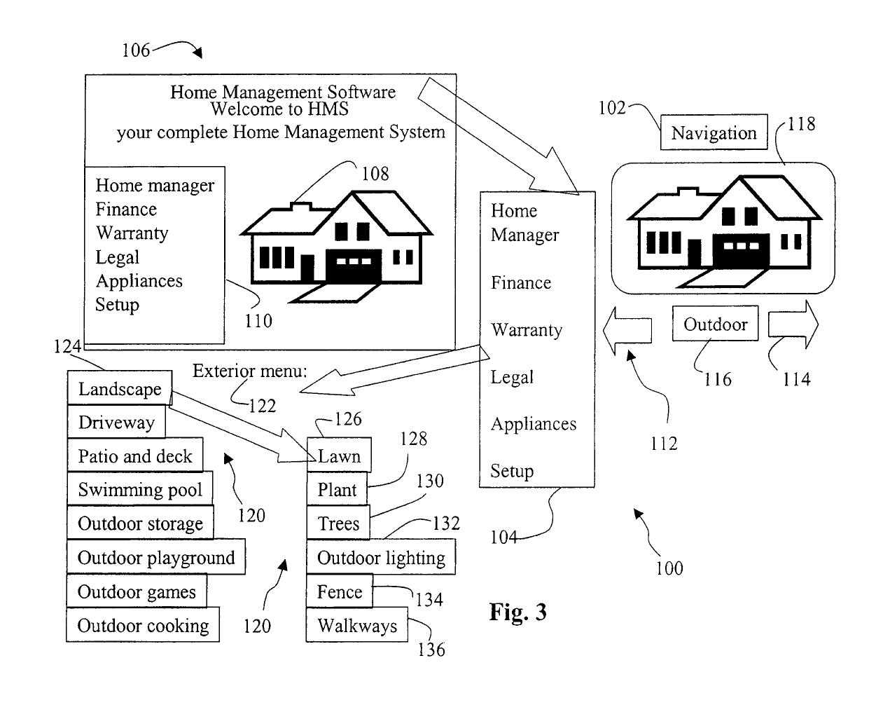

FIG. 3 shows an exemplary interface 100, which combines a graphical interface with a menu-based interface. The interface 100 includes a graphical, hierarchically-based view of a home 102 along with relevant information 104 about the home. The interface 100 is accessible to the homeowner for entering information, organizing information, retrieving information, or analyzing the information. Information received by the object model 88 may be automatically and/or manually organized within the model so that it can be easily retrieved for later use.

As shown in FIG. 3, a home page 105 is provided, which includes a picture 108 of a home and a pane 110 that displays links for a number of general categories relating to types of information to be stored within the object model 88. The exemplary categories shown are “Home Manager”, “Finance”, “Warranty”, “Legal”, “Appliances”, and “Setup”. These general categories, except for “Setup”, provide links to common categories of household-related information. The selection “Setup” allows a homeowner to configure the interface 100, for example. In a preferred embodiment, the pane 110 remains on the display for quickly selecting one of the general categories.

Selection of the “Home Manager” link brings up a Navigation page 112, which displays the graphical representation 102 of a part of a home. The graphical representations 102 displayed may be divided into general categories such as, but not limited to, internal, external, outdoor, interior, etc. Such categories may be selectable, for example, using an appropriate interface such as selectable arrows 114 shown on the display. FIG. 3 indicates the outdoor 116 of the home. The outdoor graphical representation 102 includes several, individually selectable graphical objects 118 embedded within the overall picture 102. By selecting an individual graphical object 118, information relating to an analogous part of a home may be entered, retrieved, or modified.

Preferably, the interface 100 is hierarchical, including objects representing general categories of home-related information, objects representing more specific categories, and objects representing specific items or pieces of information. For example, the “outdoor” graphical representation 102 shown in FIG. 3 represents more specific categories 120 via graphical objects, which when selected may link to additional graphical representations 122 or menu choices. These additional representations or choices 122 may allow selection of still more specific categories, or one or more representative objects. Such a selection stores information within the model-based database 90 according to the object model-based information platform 80 and/or according to custom inputs by the user. Preferably, this is accomplished by updating one or more objects 84 in the object model-based implementation platform 80, or adding one or more objects to the platform.

Thus, by navigating the graphical representation shown in FIG. 3, particular graphical objects of the interface may be highlighted and selected to access hierarchically lower-level graphical representations and objects. As shown in FIG. 3, for example, a homeowner may select, from the Outdoor graphical representation 102 shown, a graphical object 118 representing an exterior of the home. A list of icons 122 is displayed representing more specific categories of information relating to the home exterior. Then, if the homeowner wishes to add or modify objects relating to landscaping of the home, he or she may select a suitable graphical object 124 representing “landscaping”. From this selection, the sub-menu 120 or group of smaller graphical objects is presented to the user relating to more specific categories of “Landscape” 124, such as “Lawn” 126, “Plant” 128, “Trees” 130, “Outdoor lighting” 132, “Fence” 134, and “Walkways” 136. By selecting one of these additional objects, additional choices may be presented, until one or more items are selected for adding or modifying objects.

Via the input data platform 82, the user introduces information by adding or modifying objects 84 of the object model-based information platform 80. Preferably, the object model-based information platform 80 includes a plurality of objects representing items relating to a home. These objects preferably are pre-linked to represent physical links. Thus, a user can either modify a pre-existing object or add an object to the object model-based information platform 80. Modifying pre-existing and pre-linked objects provides an easier way to populate the model-based database, but in certain cases customization may be necessary depending on the information desired to be stored. Additionally, attributes of objects may be modified or newly-created by a user to populate the model-based database 90.

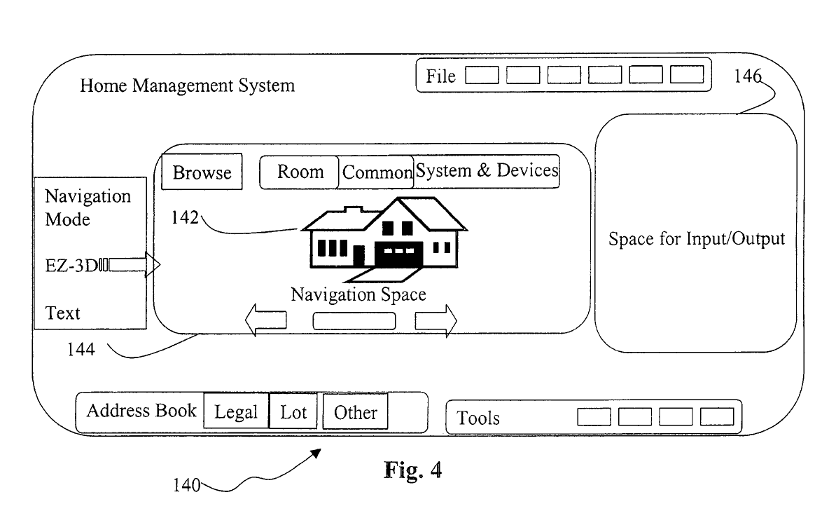

For example, FIG. 4 shows an interface 140 for storing information by modifying pre-existing objects. By selecting one or more graphical objects 142 within a navigation space 144, a user can select a pre-existing and pre-linked object to modify, such as by indicating that a particular item is now part of a home. Once selected, the model-based database 90 is populated according to the object model-based information platform 80 by modifying one or more pre-existing objects 84. An input/output space 146 may be provided for displaying particular selections.

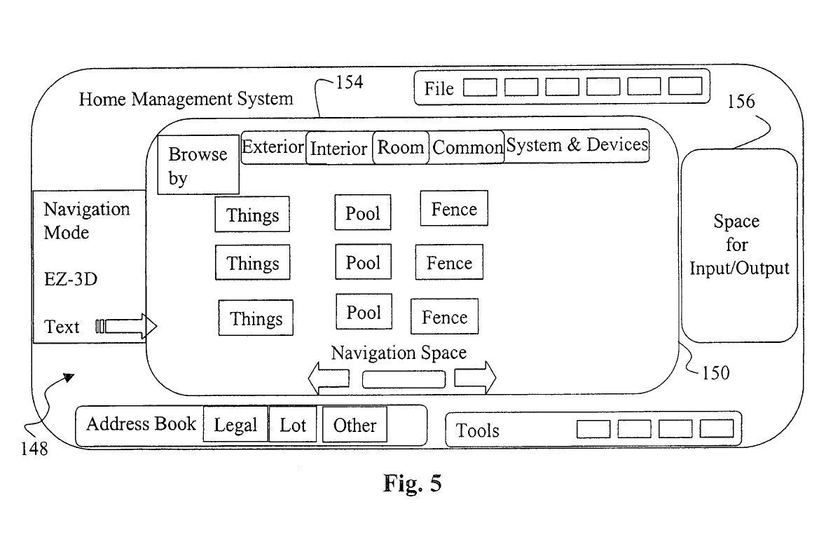

As shown, the preferred object model-based information platform 80 includes pre-existing objects 84, and links 86, and objects preferably include default attributes. Alternatively, via an interface 148, such as that shown in FIG. 5, linking one or more objects or creating one or more objects to represent a particular item may be manually performed by a user. As shown in FIG. 5, a user may navigate a space 150 in the graphical interface 148 to manually create objects and attributes thereof, and add them to the object model-based information platform. To ease object creation, templates 152 of common types of objects may be provided, organized by types 154 if desired, which can be modified by a user to create new objects. In an exemplary process, the homeowner selects via the graphical interface 148 a blank box, and assigns that box to a new item, thus creating a new object. As certain objects by default may include particular attributes, a homeowner may manually, or the object model-based information platform 80 may automatically, create new objects having similar attributes as default objects 84 in the existing platform or those previously created by a user. In an exemplary manual selection process, by creating a new object and dragging an already-created object (such as template 152) into the new object, attributes of the other objects may be used to populate the attributes of the newly-created object.

With that new object created, the homeowner may provide the name of the object and attributes for that object and/or may link the new object to other objects (either pre-existing or other newly-created objects). The navigation space 150 may be organized in any suitable manner. A space for input/output 156 may be provided to display particular selections, as with the interface 140.

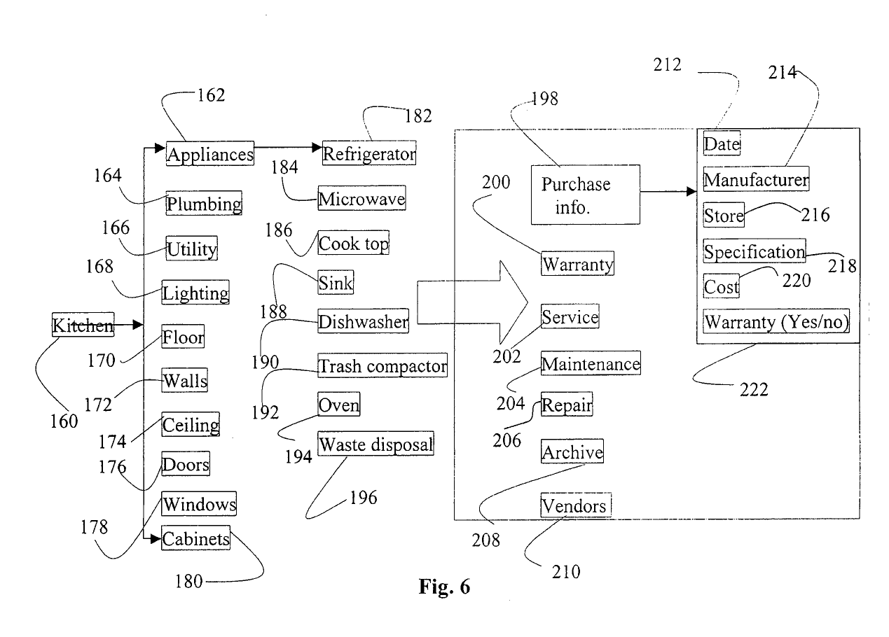

FIG. 6 shows a general example of information flow within the model-based database 90 for creating, accessing, or modifying objects. By selecting a higher-level graphical object via the input data platform 82, a user may then access lower-level objects. For example, a homeowner may select a higher-level object such as Interior (representing the interior of a house), e.g., using the arrows 114 shown in FIG. 3, and further select a lower-level object such as Kitchen 160. From there, the homeowner may select a particular appliance in a kitchen, so that an object may be accessed. These lower level objects may contain attributes relating to information such as, but not limited to, purchase history, manufacturer's information, warranty information, service history, repair history, replacement information, etc. Such information may be updated, retrieved, deleted, etc. to populate the model-based database 90. It is also contemplated that objects representing no longer relevant components (such as an old appliance) may be archived, but still accessible to retrieve related information if desired. Such information may also be deleted.

More particularly, FIG. 6 shows a hierarchically organized portion of the object model-based information platform relating to a kitchen. The upper level object, Kitchen 160, is related to several lower-level objects, such as Appliances 162, Plumbing 164, Utility 166, Lighting 168, Floor 170, Walls 172, Ceiling 174, Doors 176, Windows 178, and Cabinets 180. The Appliances object 162 is in turn related to still-lower level objects such as Refrigerator 182, Microwave 184, Cook-top 186, Sink 188, Dishwasher 190, Trash Compactor 192, Oven 194, and Waste disposal 196. Of these individual appliances, each includes attributes such as “Purchase information” 198, “Warranty” 200, “Service” 202, “Maintenance” 204, “Repair” 206, “Archives” 208, and “Vendors” 210. “Purchase information” 198 itself may further include attributes such as “Date” 212, “Manufacture” 214, “Store” 216, “Specification” 218, “Cost” 220, and “Warranty (yes/no)” 222. Within the model-based database 90, these attributes can be grouped easily for reporting, for example. For example, a user can sort the model-based database 90 by the “Purchase information” attribute 198 to provide a report showing what items have been purchased last year and at what costs.

By providing a graphical interface 140, 148 as shown in FIGS. 3-4, for example, a user will be able to navigate hierarchically through the home to retrieve or enter information by selecting or creating the appropriate object. By linking the objects 84 with the graphical objects 142 in the navigable interface 140, 148, a user will intuitively be able to retrieve or update, correct, etc. the information. As an alternative to the graphical interface, it is contemplated that a purely menu-driven interface such as the menu 122 shown in FIG. 3 may be used by a homeowner to retrieve or update information. Such a menu-driven interface 122 may display progressively-specific menus for selecting categories or items. It is also contemplated that a combination of graphical representations and menus may be used in an interface to provide easier and more intuitive navigation of the interface.

Additionally, new objects related to one or more of the present objects 84 may be added to the object model-based information platform 80, e.g., via the interface 148 in FIG. 4, and stored within the platform with customized links. These new objects are stored within the model-based database 90. Accordingly, information regarding a household may be retrieved, updated, analyzed, etc. as soon as the information is added to the object model 88.

It will be understood by those of ordinary skill in the art that such information may be presented in various ways. It is preferred that the home, for example, be represented by hierarchical layers of objects, because this provides a useful way to organize such objects. However, it is also preferred that certain objects have more than one higher-level object (parent). This allows more direct linking in some cases, and more useful categorization of particular information. For example, all of the appliances may be linked to a higher-level object, such as Major home appliances, as a category, or another higher-level object may be created for Kitchen 160, as shown in FIG. 6, which may contain (be linked to) lower-level kitchen-related objects, or both. A preferred object model-based information platform 80 provides flexibility at least in that various higher-level objects 84 may be linked to one or more lower-level objects.

As another example, the Floor object 170, as shown in FIG. 6 having a higher-level object Kitchen 160, may also appear as a sub-object for a higher-level object, Flooring, and this object may include lower-level objects that include complete flooring information for the entire home. In this way, it is to be understood that, though the objects 84 in the object model-based information platform 80 preferably may be accessible via strict hierarchical navigation, it is preferred that the objects may be linked to more than one higher-level object, thus creating a virtual web of associations.

In automatic generation, pre-existing objects are modified by the homeowner, and the objects are automatically linked with other objects by default. For example, a modified “Kitchen sink” object 188 would be linked by default to the higher-level “Kitchen” object 160. In manual generation, by contrast, the homeowner can define and link a new object. Technology for providing such links may be provided by, for example, object oriented programming language and platforms such as MS Visual.net Enterprise Architect.

As shown in FIG. 6, particular attributes for lower-level objects may be automatically created and linked to a newly-created object. For example, the attribute “Purchase information” 198 may automatically include a plurality of lower-level attributes such as “Date” 212, “Manufacturer” 214, “Store” 216, “Specification” 218, “Cost” 220, and “Warranty” 222. Alternatively, the “Purchase information” attribute 198 may automatically contain a series of attributes that are filled with default values until changed by a user, for example.

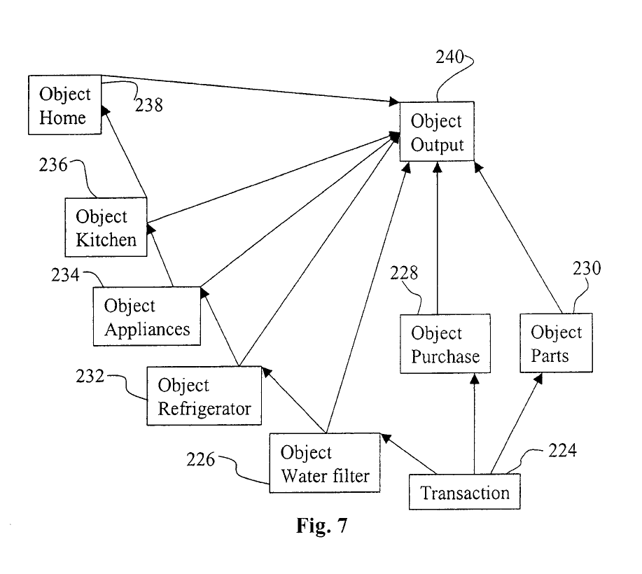

Once links are established for newly-created objects or objects are modified by a user so as to make them available for a particular software model, object information will flow to other objects in a hierarchical fashion, or otherwise as appropriate. An example of information flow from a transaction is shown in FIG. 7. FIG. 7 shows a particular transaction 224, such as a purchase of a water filter, represented by a new object. The transaction 224, in turn, is linked to three higher-level objects within the object model-based information platform: Water filter 226, Purchase 228, and Parts 230. Object Water filter 226 is in turn linked to a still-higher level object Refrigerator 232, which is linked in turn is linked to progressively higher-level objects Appliances 234, Kitchen 236, and Home 238. The Home 238, “Kitchen” 236, Appliances 234, Water filter 226, Purchase 228, and Parts 230 objects are themselves linked to a higher level object Output 240 for report generation.

Because the information populating the object model-based information platform 80 and stored in the model-based database 90 may be processed in different ways and presented to the homeowner from different perspectives and for different reasons, a homeowner may customize a provided output and retrieve only the information that is beneficial. Such information preferably may be analyzed in any manner desired. For example, if a homeowner would like to see an amount spent in kitchen appliances since the home was purchased, in a past year, or a total service cost last year for an entire home, such information may easily be retrieved by retrieving the necessary objects 84, analyzing the objects based on the attributes provided therein, and generating a report. This is accomplished via the information processing platform 92, which processes information (reports, relationships, time, costs, etc.) from the model-based database 90 based on requests from the applications management platform 94.

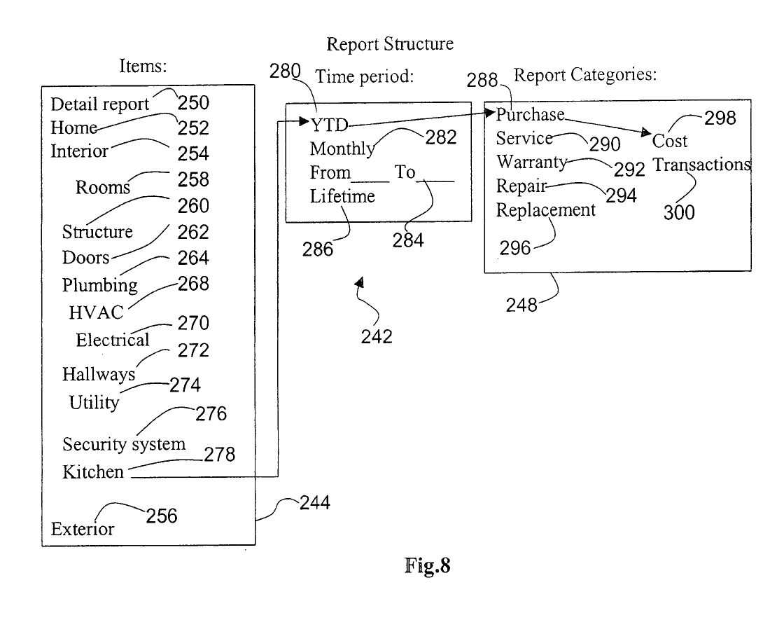

The applications management platform 94, as with the data input platform, preferably may include a menu and/or graphical interface for navigation. An example of a report menu structure 242 of the applications management platform is shown in FIG. 8. The menu structure 242 allows a homeowner to separately select sub-items of a report menu, including item or items 244 to be analyzed, a time period 246, and report category 248. For example, a homeowner may want to provide an itemized description of every repair job done in a year to date, and the itemized costs or total repair costs. As shown in the report menu structure 242 of FIG. 8, a hierarchical menu interface is provided to a user, presenting a high-level selection “Detail report” 250, with sub-items “Home” 252 and still lower-level items “Interior” 254 and “Exterior” 256. “Interior” 254, in turn, has sub-items “Rooms” 258, “Structure” 260, “Doors” 262, “Plumbing” 264, “HVAC” 268, “Electrical” 270, “Hallways” 272, “Utility” 274, “Security System” 276, and “Kitchen” 278, where indentions represent hierarchy or dependency.

With “Kitchen” 278 selected, the time period sub-menu 246 is provided to the user with sub-items such as “Year-to-date (YTD)” 280, “monthly” 282, “From ______ to ______” 284, which may be filled-in by the user, and “Lifetime” 286. Similarly, the “Report categories” sub-menu 248 may include sub-items “Purchase” 288, “Service” 290, “Warranty” 292, “Repair” 294, and “Replacement” 296. Selecting “Purchase” 288 may produce a lower-level group of report categories such as “Cost” 298 and “Transactions” 300.

Though the output menu 242 shown in FIG. 8 includes items 244, time periods 246, and report categories 248 in that order, it is contemplated that the views of the output and the hierarchy navigable by the user may be customized with other structures. For example, it is contemplated that the structure may begin with report categories linked to time periods, and then to items. Views of the output preferably are relevant, beneficial, and easily obtainable to the user.

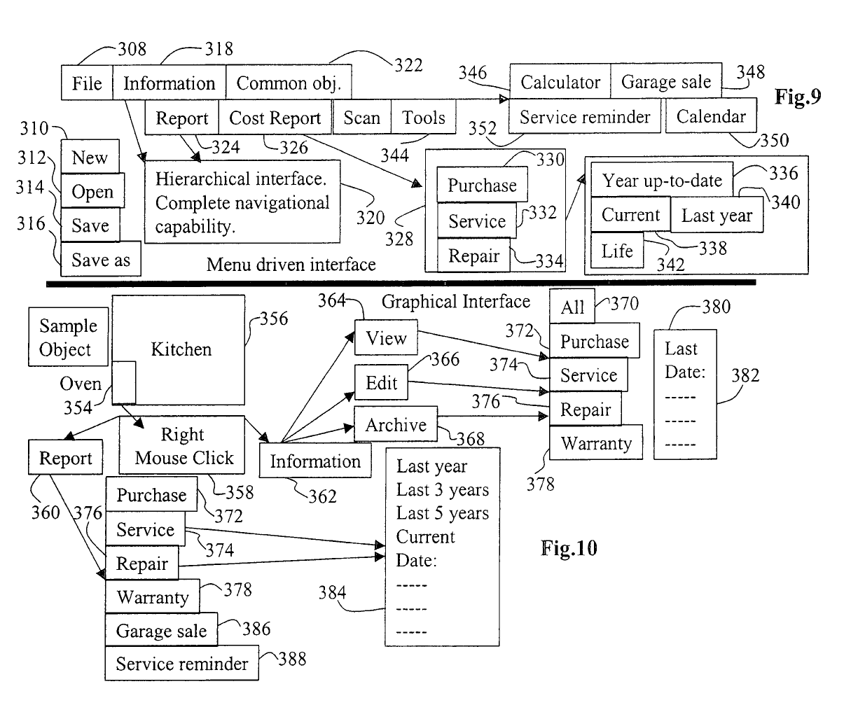

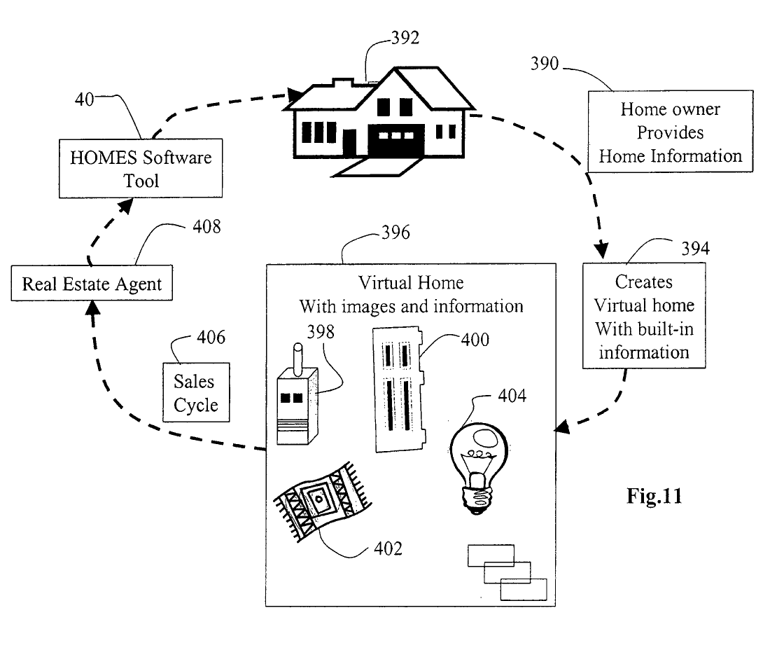

FIGS. 9-10 illustrate an exemplary menu-driven interface 302 and a partial graphical interface 304, respectively, for the home management system 40, which includes an interface of the applications management platform 94. As shown in FIGS. 9-10, the interface 302, 304 for the applications management platform 94 may be integrated with the interface for the input data platform 82, or vice versa.

The exemplary menu-driven interface 302 shown in FIG. 9 includes a drop-down menu 306 having selections “File” 308 (with further menu items “New” 310, “Open” 312, “Save” 314, and “Save as” 316). For selection or updating of information, the menu 306 includes menu selection “Information” 318, which provides a menu or graphical interface 320 of the input data platform, for example. Selection “Common object” 322 allows a homeowner to make global changes for adding or updating common objects. Selections “Report” 324 and “Cost report” 326 allow a homeowner to generate reports via the applications management platform 94 and the information processing platform 92.

For example, selecting “Report” 324 leads to the hierarchal menu interface 320 of the applications management platform 94 for generating a report. Selecting “Cost report” 326 also leads to a menu interface 328 of the applications management platform 94, and may include hierarchal lower selections such as “Purchase” 330, “Service” 332, and “Repair” 334. Selectable time restrictions may include “Year-to-Date” 336, “Current” 338, “Last Year” 340, and “Life” 342.

Other types of operations may be possible using the applications management platform. For example, a “Tools” selection 344 is also provided in FIG. 9, and includes tools such as “Calculator” 346, “Garage sale” 348 (itemization and cost of particular objects or particular household items), “Calendar” 350, and “Service reminder” 352.

FIG. 10 shows the partial graphical interface 304 incorporating both interfaces of the input data platform 82 and the applications management platform 94, using a sample graphical object 354. This graphical object 354 is linked, via coordinates or otherwise, to object Oven of the object model-based information platform 80. Further, another graphical object 356 is linked with object Kitchen, which is a parent object to Oven. Selecting Oven, such as via a right mouse click 358 on the graphical illustration of the oven (object 354), provides general options for the applications management platform 94 and/or the input data platform 82, such as selections “Report” 360 and “Information” 362. Selecting “Information” 362 leads to submenu options “View” 364, “Edit” 366, and “Archive” 368. “View” 364 provides a chance to view information related to the oven, provided by retrieving d a t a using the applications management platform 94. “Edit” 366 provides an opportunity to edit the information via the object model-based information platform 80. “Archive” 368 allows a homeowner to archive oven-related objects via the object model-based information platform 80, which may be useful, for example, if the oven has been replaced with a newer one.

Each of selections “View” 364, “Edit” 366, and “Archive” 368 may themselves include submenus for narrowing the category of information for the retrieved or edited objects such as “All” 370, “Purchase” 372, “Service” 374, “Repair” 376, and “Warranty” 378. Selecting “Service” 374 or “Repair” 376 may introduce a “time” selection 380, such as a blank 382 for entering the last date of service or repair desired. Selecting “Report” 360 may also provide additional features provided by the applications management platform 94, including similar sub-selections as with “View” 364, for example, with suitable time restrictions 384, and additional selections, such as “Garage Sale” 380 and “Service Reminder” 388.

Those of ordinary skill in the art will appreciate the various types of technologies that may be used to implement parts of the home management system 40. For example, languages such as Java or other languages may be used to implement an object-based software algorithm used for the object model-based information platform 80. In an exemplary system, reliability, flexibility, adaptability, and robustness are criteria for selecting an appropriate implementation technology. It is preferred that the software selected can be used for both stand-alone and Internet- (preferably Web) based applications. In an exemplary embodiment, Microsoft net technology platform for Windows OS is used. Other platforms, such as Java, may be used.

A preferred separate technology, such as MS DirectX is used to capture relationships between different objects as they are physically linked, transfer such relationships to the database 90, and then provide an interface for the input data platform 82 and the applications management platform 94 so that a homeowner can navigate the objects following the relationships captured. In an exemplary embodiment, a graphical tool such as Shockwave Flash or other graphical tool may be used to create graphical objects for the input data platform 82 and the applications management platform 94. Such graphical objects can be linked via a net programming environment such as C#. The advantage of such an approach is flexibility at the object level. In this way, the user can select a large variety of objects to define information relating to the home. Such objects, in a preferred software model, can be edited, modified, added, or deleted easily. However, programming effort to manage objects preferably is rigorous. For example, when a new object 84 is created it should be graphically represented and hard coded to the model-based database 90 to link the graphics with the object data.

In an alternative software approach, Microsoft DirectX programming environment can be used to link up the model-based database 90 with a computer-aided drafting (CAD) tool. Such a CAD tool can be used to create a three-dimensional view of a home that is already populated with all of the applicable objects 84 defined. Based on a user's input, such as during a configuration process, graphical elements related only to objects defined may be displayed by the CAD tool. For example, if a homeowner owns a house with a backyard, but without a swimming pool, the house and backyard are displayed, but a swimming pool is not. Database linking and programming can be supported easily in either of these approaches.

For the model-based database 90 and the information processing platform 92, suitable database technology, for example, may be implemented using Microsoft Access, or server-based databases, as non-limiting examples. By using a net platform, for example, the home management system 40 may be implemented either as a stand-alone application or a network-based (Web-based) application.

The home management system 40 may be used by a homeowner during any of various time frames. For example, a homeowner may collect information during building of a new home. Such information may, for example, include information supplied by a builder. As another example, the homeowner may collect information when purchasing an existing home, and such information may be supplemented by a previous homeowner or a real estate agent. A homeowner may also begin using the system 40 after a household is built or purchased and populate the database, either manually or automatically. Each of these time frames may affect how the home management system 40 is employed.

Generally, there are three preferred methods of providing inputs to the home management system. For new construction, for example, a first input process may be provided via a suitable interface of the input data platform 82 to capture information generated during construction of a home from a builder's database, including but not limited to as-built drawings such as the CAD input 52. Information relating to equipment, appliances, components, etc. may be captured from a database to create a comprehensive view of a home, as represented by the object model-based information platform 80.

For example, though the preferred home-management system 40 may be useful for new and existing homes, populating the model-based database 90 may be easier for a new home as opposed to an existing home market. The content that may be provided for a new home may potentially be much more expanded and comprehensive than that for an existing home market. To account for this, the process for obtaining information may be different for an existing home market as opposed to a new home.

For new construction, data for the object model-based information platform 80 may be obtained, for example, for all equipment provided by the builder and their suppliers, for home configurations via an as-built drawing for electrical wiring, structure, etc., for legal information, or for other information. If information is provided that can be represented graphically, this information may be incorporated into a suitable graphical interface. For example, using detailed drawings, a 3-D home model may be built clearly showing the frame of the house, or how plumbing piping is laid out, or the correct location of valves or air ducts.

Capturing construction data, as-Built information, and data related to products, components, and equipments provided by the builder can be captured using various technologies. Autocad, for example, uses object modeling technologies to define graphical objects in architectural, mechanical, electrical, plumbing etc. drawings for a home. Object modeling allows a designer to provide information related to an graphical object, i.e. a line representing wall. The information that is now attached to this specific line or wall can have the wall properties, costs, and other information. Therefore, it is contemplated that CAD drawings along with the information in the object model 88 can be used as inputs to the object model-based information platform 80.

In an alternative embodiment, builders typically use product codes to define different components and equipments that are being supplied. Often, the product codes that are used follow the standard definition of codes as specified by an Industry organization such as Construction Specification Institute or CSI. The use of such standard product codes provides a method to exchange object model information between the builders and the system 40. For example, the object model-based information platform 80 can include product codes. When home information is provided, the platform 80 can match the product codes between the outside party's database and the model-based database 90 to import and populate the object model 88 with the relevant data.

Providing such information completely, clearly, and intuitively can provide significant value for use in operation, service, improvements, or maintenance for a home. In the case of a water leak, for example, a plumber may know an exact location of that leak using a suitable 3-D model. As the new home is built, the builder can populate the model-based database 90 using such information for all material and equipment that exists in a home. This model-based database 90 provides a rich information model for a new home. Thus, when a homeowner moves into his or her new home, the model-based database 90 into which the object model-based information platform 80 is implemented may be delivered to the homeowner, and may contain significant information he or she may need to know about the home. The model-based database 90, for example, may be delivered via a storage medium such as compact disc (CD) 72 or may be downloaded via a Web site from the builder, for example. The input data platform 82, the applications management platform 94, and the information processing platform 92 may be used to navigate and/or analyze the model-based database 90.

Using the model-based database 90 provided by the builder as a starting point, the home management system provides a platform for the homeowner that may be used for the life of the house to maintain a clearinghouse of information related to the home. For example, the model-based database 90 may contain updated information relating to repair, replacement, service, updates, and maintenance of the home.

For a new home, a home builder may market the new home to a potential home buyer. By providing the model-based database 90 including details relating to components for such a new home, a home builder may be able to distribute home information efficiently to a potential buyer for consideration of purchase of a home. As the home is being built, the model-based database 90 may be populated using as much information as desired, and from this point, the database may be used or updated by the homeowner as desired after purchase.

A second type of information input is manual input. For example, a user may create objects and provide contents manually using the input data platform 82 built into the system 40, as described above. Templates may include, for example, common types of information with pre-defined attributes. A user may drag a template to a newly-created object to define attributes for that object, including, for example, how that object is linked to other objects 84 in the database 90.

For example, the model-based database 90 for an existing home, to provide maximum usefulness, may need to be populated by input from a homeowner. By providing the home management system 40 to a user, including the data input platform 82, the model-based database 90 may be populated with as much information as a user is willing to provide, thus making the object model 88 as complete or as incomplete as desired. It is also contemplated that information may be stored outside of the home management system 40 and later linked with the system to populate or partially populate the model-based database 90. This outside information may exist as a machine readable medium, as a propagated signal as part of a downloadable program or as part of a network relationship, such as a server/client or Web-based model to implement the system. If the home management system is provided as a software tool, it may be distributed, for example, via the Internet, or in a medium such as shrink-wrapped software. Once created, the information added to or modified in the system 40 is preferably instantly available to the user, because it is incorporated within a default or customized object framework.

After the model-based database 90 is initially populated, the object model 88 then may contain information such as when an existing home was purchased, and afterward, information such as repair, service, maintenance, or discard of home articles or activities. For a later transfer to a new homeowner, such as a home sale, the model-based database 90 may be provided via a suitable storage medium or downloaded from the seller or a real estate agent for presenting accessible information to a potential homebuyer for use in considering a purchase. It is contemplated in this case that selectable portions of the object model 88 may be kept private and not transferred to the medium or for download, for example if information relating to home occupants, legal information, etc. has been previously stored in the object model.

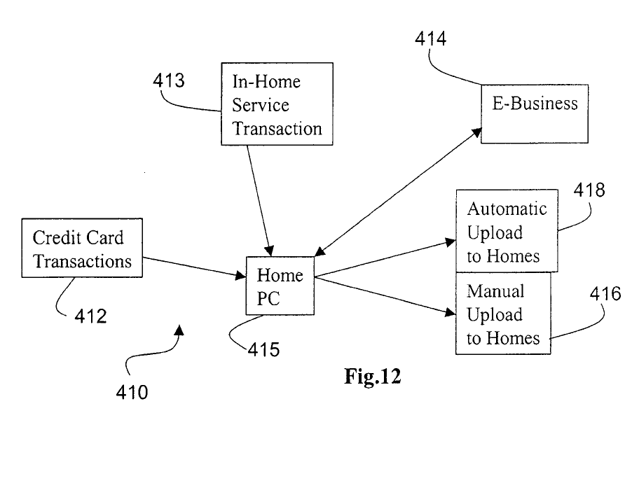

For example, as shown in FIG. 11, the homeowner may provide home information to the home management system 390, and this information is used to populate the model-based database 90. Access to the object model 88 is provided with the data input platform 82, including a graphical interface illustrating parts of a house 392. The graphical interface may include, for example, CAD illustrations as described above, Flash illustrations, or other graphical tool illustrations, and/or may be integrated with existing illustrations or pictures, such as photographs of the house. A series of photographs, (e.g., panoramic photographs) may be used to provide a “virtual home” 394 including active links to particular objects stored in the database.

In FIG. 11, a picture 396 in an exemplary graphical interface shows a living room including a furnace 398, a door 400, a carpet 402, and a light 404. Each of these images may be linked to a selectable object, for example, via predefined or user-defined coordinates, such that clicking on a graphical object or area of the picture 396 provides information relating to that item, such as the age of the furnace, the type of carpet, the required wattage for the light, etc.

When the home is desired to be sold by the owner during a sales cycle 406, a real estate agent 408 may be provided with the home management system (with suitable data extraction if desired) 40, preferably at least the model-based database 90, and the real estate agent may provide the model-based database to a potential homebuyer. As opposed to providing a storage medium, it is also contemplated that a virtual tour or other presentation may be provided in a client/server model or otherwise accessible via the Web. The home management system 40, as will be understood by those of ordinary skill in the art, may be implemented on various platforms, and preferably is as platform independent as possible for easier access.

A third method of input includes a transfer of information contents over a network interface (link) from outside parties, such as outside vendors or business. This type of transfer preferably is a direct transfer, and is used to populate the objects in the database 90 automatically. In a preferred embodiment, the home management system 40 provides a channel of information between homeowners and such outside parties to provide services and goods to the homeowners.

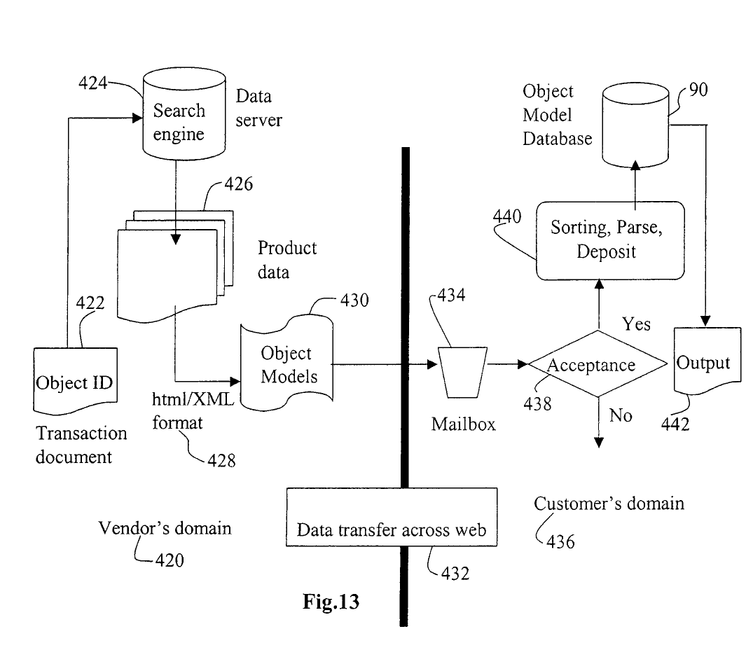

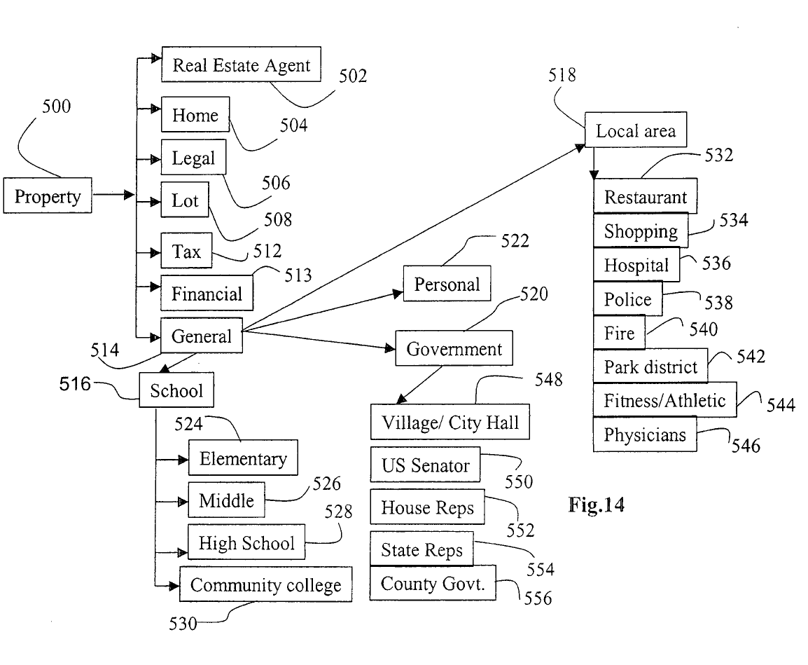

FIG. 12 shows an exemplary business transaction model 410 incorporating the home management system 40. As shown in FIG. 12, a transaction 412 at a location of an outside party, an in-home service 413, or an online transaction 414, or information relating to these transactions, is sent to a personal computer 415 of a homeowner in which the home management system 40 is installed. Within the personal computer 415, the homeowner can manually select and upload data 416 for incorporation within the model-based database 90, and/or the information may automatically upload 418 to the system 40 to populate the database, for example as shown in FIG. 13.

A starting point in a business transaction 412, 413, 414 may take place, for example, at an outside party site such as a checkout counter of a store. If the shopper (homeowner) wishes to use the home management system 40 for storing the transaction history and/or other information (e.g., warranty, rebate, user manual, list of parts or accessories, scanned documents, etc.), the information can be stored at the outside party's Web site or electronic warehouse for later electronic retrieval by the shopper. Alternatively, the information may be directly sent to the homeowner's computer 415 via, for example, a wireless network link such as Bluetooth retrieval on a personal digital assistant (PDA) or mobile phone. When the homeowner is ready to retrieve the information from a Web site, for example, the homeowner may log into the Web site, select a command to download the information, and download the information.

For example, in the method shown in FIG. 13, when a business transaction 412, 413, 414 takes place, such as but not limited to a financial transaction, the home management system 40 may retrieve information related to that transaction readily. More particularly, at the outside party's domain 420, a transaction document 422 indicates particular information related to the transaction. This document 422 is searched by a search engine 424 of a data server to provide product data 426. Such data, for example, may be formatted, such as HTML or XML formatting 428, to provide object models 430 representing information of the transaction. The object model data is transmitted via the Web 432 to the homeowner's (customer's) mailbox 434. For example, information packets can be directly emailed to the homeowner after the financial transaction 412, 413, 414 takes place. Instead of using a Web site, such information may be transmitted directly to a suitable device of the user, such as a PDA or mobile phone.

The information packets may then remain at the Web mailbox 434 or other online or server mailbox for downloading by the homeowner in the homeowner's domain 436. If the data is accepted 438, the object models are sorted and parsed 440 for relevant objects and information fields, and deposited into the model-based database 90, preferably as specified in the object model-based information platform 80. If the information is not accepted, it may be discarded. If the information matches existing object models 88 then the new objects are incorporated into the object model. If the information does not match, then a new object is created, and is linked to an existing hierarchy manually (by the homeowner) or automatically (but preferably acknowledged by the user) so that the information can be organized within the model-based database 90. The information stored in the model-based database 90 is then available via the applications management platform 94 for inspection by the homeowner, and possible generation of output 442.

In this way, the home management system 40 automatically places information into the correct location within the system by creating or modifying appropriate objects. The home management system 40 may directly receive and incorporate the information, or alternatively a homeowner's computer 415 may receive the information first, and then synchronize with the home management system 40 to further populate the model-based database 90.

Such a system 40, for example, potentially saves money for outside parties by reducing the time and cost of printing a paper receipt, and provides a significant business value by sending a transaction document to a safe and secure place that can be retrieved by the homeowner easily when needed. It is preferred that the home management system 40 include suitable security features for items desired to be kept private, such as particular financial or legal information.

Prior to the present system 40, it has been common for homeowners to lose receipts or other evidence of transactions. Homeowners often are frustrated with the need to save numerous receipts and manage them for refunds, exchange, service, warranties, etc. By creating this communication between the home management system 40 and outside parties such as businesses, for example, the outside parties, with permission from the homeowners, may use the communication channels established to send product information such as product updates, recall notices, maintenance schedules, and/or other information. This information, again, may directly populate the model-based database 90, and/or may be saved in a temporary location, such as a temporary basket or file on the homeowner's PC 415 or a server for download, so that the homeowner can manually screen and select information for inclusion in the home management system 40.

Once the information is downloaded or otherwise received by the homeowner, parse tools may be used to dissect the packets of information and search for specific fields such as cost, date of purchase, manufacturer's information, product warranty, etc. These fields are matched against the object types and higher-level objects (categories) present within the object model 88 (default, or those created manually by the user). Accordingly, the parsed information packets are incorporated into the object model 88 so that they are efficiently and intuitively accessible later by the homeowner.

Another embodiment of automatic search and storing or populating of object model information with what has been provided by the outside party can use a pattern matching algorithm commonly found in Artificial Intelligence for natural language recognition. In this embodiment, the words that describe home objects can be stored within the model-based database 90 according to the object model-based information platform 80. When new information comes from the outside party, the algorithm scans the information and matches similar words that are in the model-based database 90 with the contents of a new piece of information. For example, from a transaction document, the algorithm matches words such as Refrigerator, Sales, date ______, $______. Once several of such similar words are found, the system 40 can then recognize that the transaction is related to a new refrigerator and then pass on this information to the appropriate object 84 within the object model 88.

Another embodiment includes creating IDs for various objects and formatting a transaction document that will make it easier for the software to read data and populate object models. This can be accomplished, for example, by matching the IDs between the outside party's information content and what is already stored within the model-based database 90. Once the IDs are matched, the home management system 40 transfers the objects that are represented by the matched IDs.

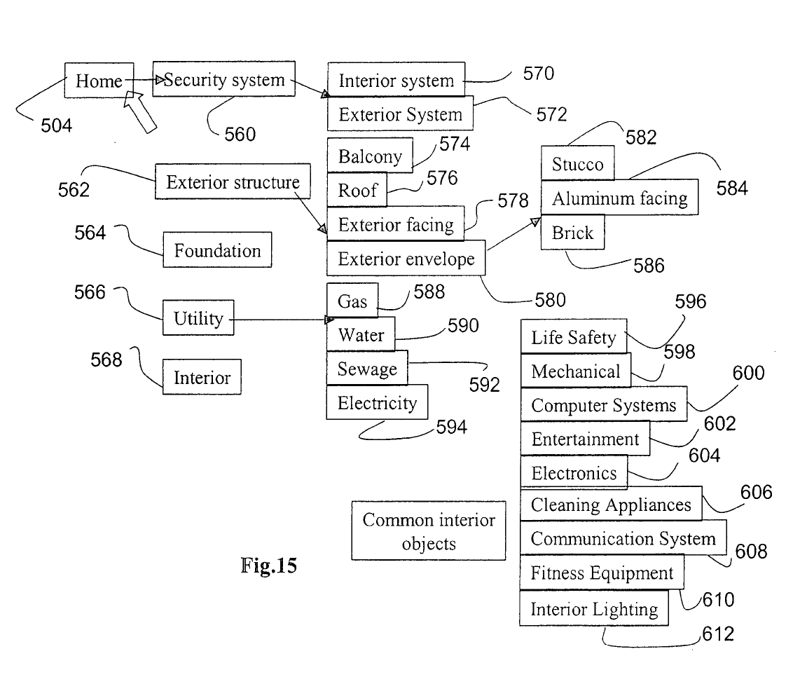

The following is a description of an exemplary partial object model for the object model-based information platform 80 of the home management system 40, focusing on information relating to real estate property. FIG. 14 shows exemplary sub-objects for Property. Object Property 500 is linked to sub-objects Real Estate Agent 502, Home 504, Legal 506, Lot 508, Tax 510, Financial 512, and General 514. The General object 514, for example, may include sub-objects School 516, Local Area 518, Government 520, and Personal 522. School 516, in turn, may be linked to still lower-level objects Elementary 524, Middle 526, High School 528, and Community college 530 objects. Local Area 518 sub-objects, relating to information about the area of the home, include Restaurant 532, Shopping 534, Hospital 536, Police 538, Fire 540, Park district 542, Fitness/Athletic 544, and Physicians 546. The Government 520 sub-object may include lower-level objects Village/City Hall 548, U.S. Senator 550, House Representatives 552, State Representatives 554, and County Government 556. The Personal sub-object 522 may include other sub-objects.

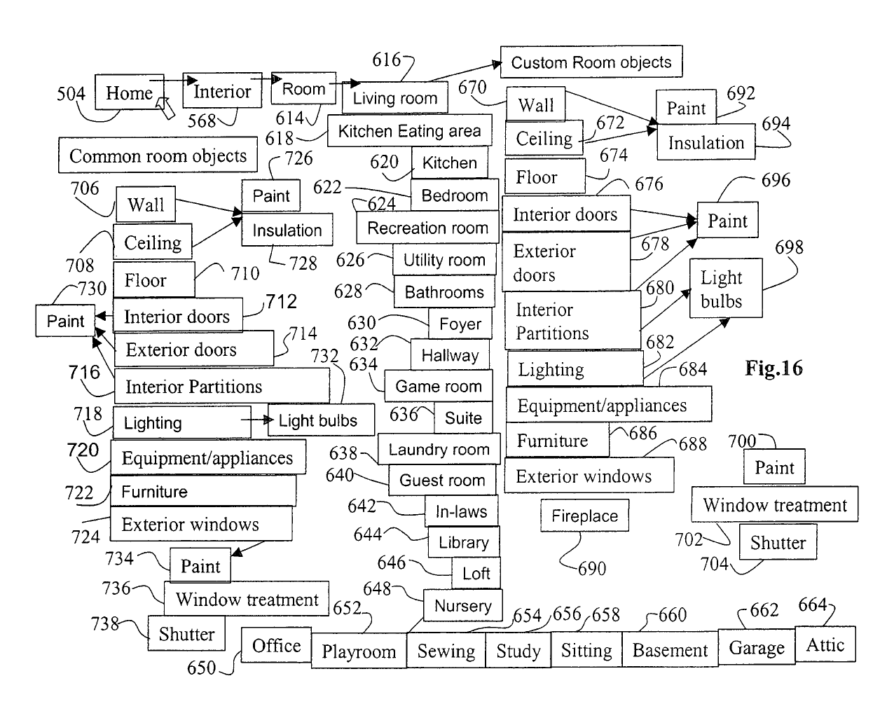

FIG. 15 illustrates exemplary sub-objects of object Home 504 (a sub-object of Property 500). Home 504 includes sub-objects such as Security System 560, Exterior Structure 562, Foundation 564, Utility 566, and Interior 568. Of these, Security System 560 includes sub-objects such as Interior System 570, Exterior System 572, and Exterior Structure 562 includes sub-objects Balcony 574, Roof 576, Exterior Facing 578, and Exterior Envelope 580. Lower-level objects of Exterior Envelope 580 include Stucco 582, Aluminum Facing 584, and Brick 586. Object Utility 566 may include sub-objects such as Gas 588, Water 590, Sewage 592, and Electricity 594.

Object Interior 568 may have common sub-objects such as Life safety 596, Mechanical 598, Computer systems 600, Entertainment 602, Electronics 604, Cleaning appliances 606, Communication systems 608, Business equipment 610, and/or Interior Lighting 612. These objects and others in the object model are referred to herein as “common objects”, because they allow a homeowner to make global edits to the objects, which then propagate for similar objects across the model 88. A homeowner may use a “global object” command, for example, to select common objects. The homeowner may further choose which objects may be used for global command (i.e., common objects), and which objects may be linked only to a particular higher-level object (i.e., custom objects).

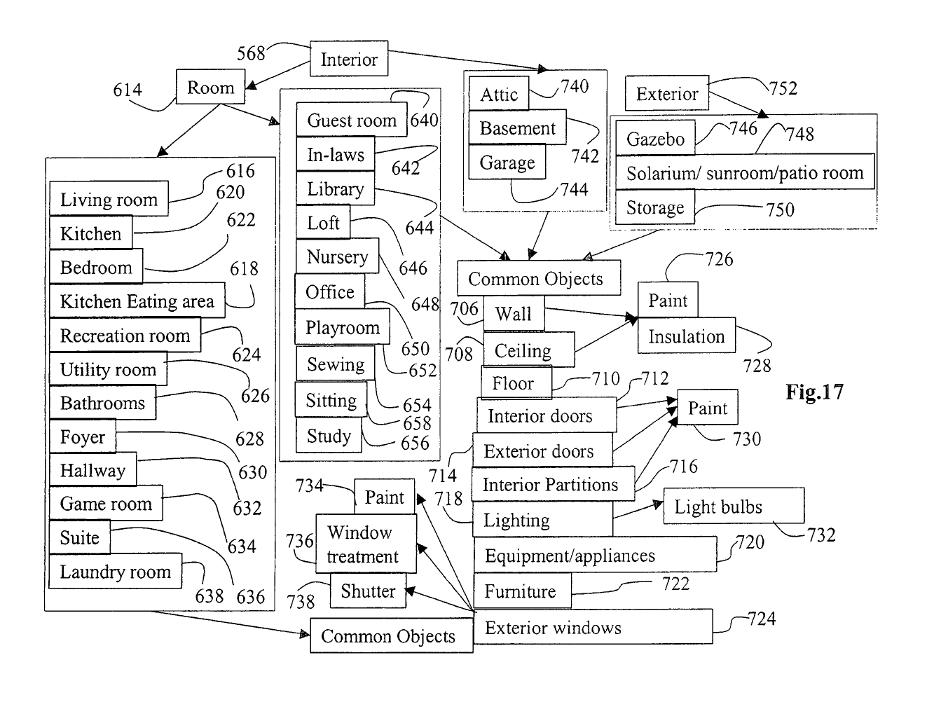

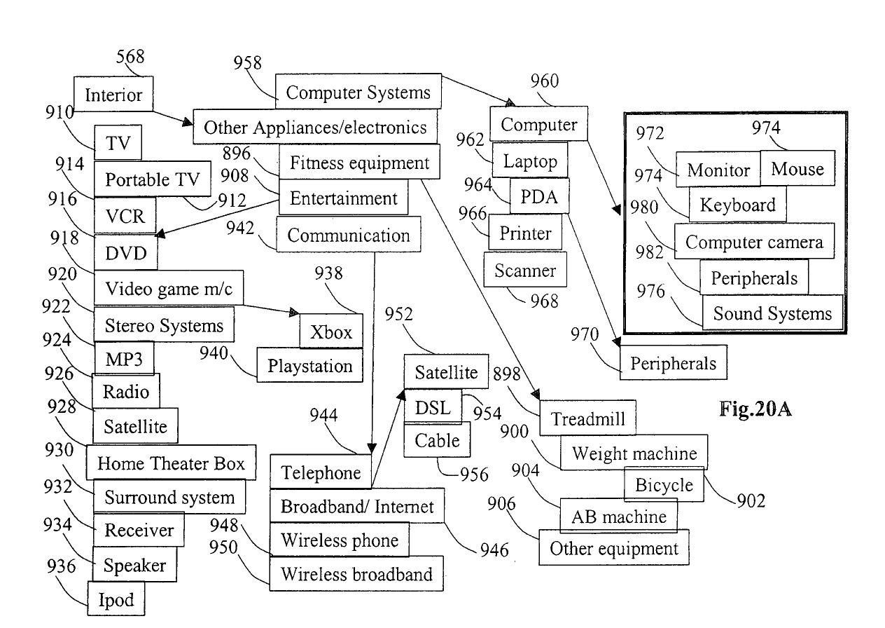

FIGS. 16-21 illustrate exemplary sub-objects of Interior 568 that are hierarchically linked to Interior (custom objects). As shown in FIG. 16, object Interior includes sub-object Room 614, which in turn includes sub-objects Living room 616, Kitchen eating area 618, Kitchen 620, Bedroom 622, Recreation room 624, Utility room 626, Bathrooms 628, Foyer 630, Hallway 632, Game room 634, Suite 636, Laundry room 638, Guest room 640, In-laws 642, Library 644, Loft 646, Nursery 648, Office 650, Playroom 652, Sewing 654, Study 656, Sitting 658, Basement 660, Garage 662, and Attic 664. Each of these objects may include one or more custom objects, which may include, for example, Wall 670, Ceiling 672, Floor 674, Interior doors 676, Exterior doors 678, Interior partitions 680, Lighting 682, Equipment/Appliances 684, Furniture 686, and Exterior windows 688. Individual rooms may have their own custom sub-objects such as Fireplace 690 for Living Room 616. Other rooms, such as Kitchen 620, may include a significant number of custom objects, as shown in FIG. 19.

The custom objects may themselves have sub-objects. For example, Wall 670 and Ceiling 672 each may include sub-objects Paint 692 and Insulation 694. Interior doors 676, Exterior doors 678, and Interior partitions 680 may include sub-objects Paint 696. Lighting 682 may include sub-object Light bulbs 698. Sub-object Exterior windows 688 may itself include sub-objects Paint 700, Window Treatment 702, and Shutter 704.

Common objects relating to rooms may be similar to the custom room sub-objects listed above, but may be globally changed by a homeowner. Such common room objects thus may include Wall 706, Ceiling 708, Floor 710, Interior doors 712, Exterior doors 714, Interior partitions 716, Lighting 718, Equipment/appliances 720, Furniture 722, and Exterior Windows 724. These objects may themselves have sub-objects, as with the custom room objects. For example, Wall 706 and Ceiling 708 each have sub-objects Paint 726 and Insulation 728. Interior doors 712, Exterior doors 714, and Interior partitions 716 may include sub-object Paint 730. Lighting 718 may include sub-object Light bulbs 732. Sub-object Exterior windows 724 may include sub-objects Paint 734, Window treatment 736, and Shutter 738.

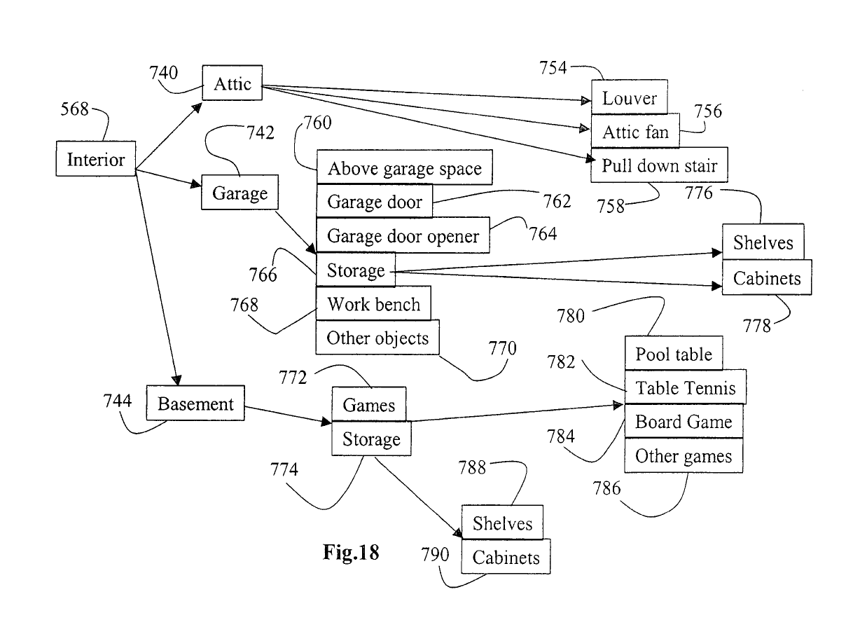

FIG. 17 illustrates the relationship between the common room objects and the sub-objects of Room 714. For example, all of the sub-objects of Room 614 shown, as well as additional Interior sub-objects Attic 740, Basement 742, and Garage 744 may include one or more of the common objects and sub-objects thereof listed above. Additionally Exterior sub-objects Gazebo 746, Solarium, Sun Room/Patio 748 and Storage 780 of object Exterior 752 may include the common room objects.

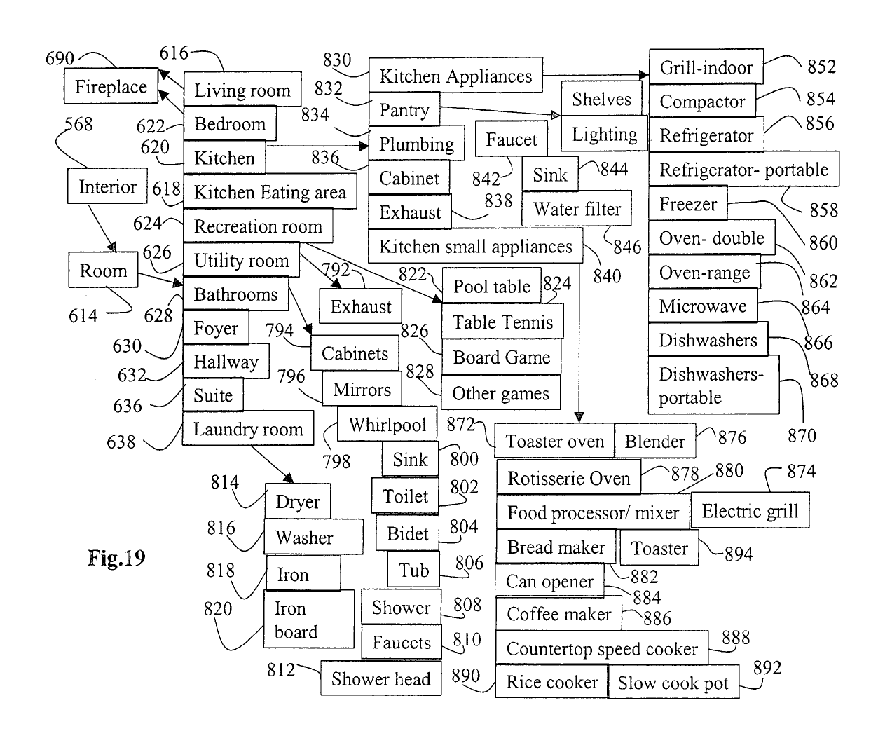

As shown in FIG. 18, in addition to the common room objects listed in FIG. 17, Objects Attic 740, Basement 742, and Garage 744 may themselves include sub-objects such as Louver 754, Attic fan 756, and Pull-down stair 758 for Attic, Above garage space 760, Garage door 762, Garage door opener 764, Storage 766, Workbench 768 and Other 770 for Garage, and Games 772 and Storage 774 for Basement. Sub-object Storage 784 may itself include sub-objects Shelves 776 and Cabinets 778. Sub-object Games 772 may include sub-objects Pool 780, Table Tennis 782, Board Game 784, and Other games 786. Storage 774 includes sub-objects Shelves 788 and Cabinets 790.

FIG. 19 shows additional custom objects for particular rooms. For example, objects Living room 616 and Bedroom 622 may include sub-objects such as Fireplace 690. Utility Room 625 may include sub-object Exhaust 792, Bathrooms 628 includes multiple sub-objects, such as Cabinets 794, Mirrors 796, Whirlpool 798, Sink 800, Toilet 802, Bidet 804, Tubs 806, Shower 808, Faucets 810, and Shower head 812, while Laundry Room 638 includes sub-objects Dryer 814, Washer 816, Iron 818, and Ironing Board 820. Similarly, Recreation room 624 includes sub-objects Pool table 822, Table tennis 824, Board game 826, and Other games 878.

Object Kitchen 620 preferably includes several sub-objects such as Kitchen appliances 830, Pantry 832, Plumbing 834, Cabinet 836, Exhaust 838, and Kitchen small appliances 840. Sub-objects for Plumbing 834 include Faucet 842, Sink 844, and Water Filter 846, and sub-objects for Pantry 832 include Shelves 848 and Lighting 850. Sub-objects for Kitchen Appliances 830 include Grill-indoor 852, Compactor 854, Refrigerator 856, Refrigerator-portable 858, Freezer 860, Oven-double 862, Oven-range 864, Microwave 866, Dishwashers 868, and Dishwashers-portable 870. Further, Kitchen small appliances 840 includes sub-objects Toaster oven 872, Electric grill 874, Blender 876, Rotisserie oven 878, Food processor/mixer 880, Bread maker 882, Can opener 884, Coffee maker 886, Countertop speed cooker 888, Rice cooker 890, Slow cook pot 892, and Toaster 894. Each of these objects, for example, have predefined attributes related to the type of object, with the option for the homeowner to add new ones.

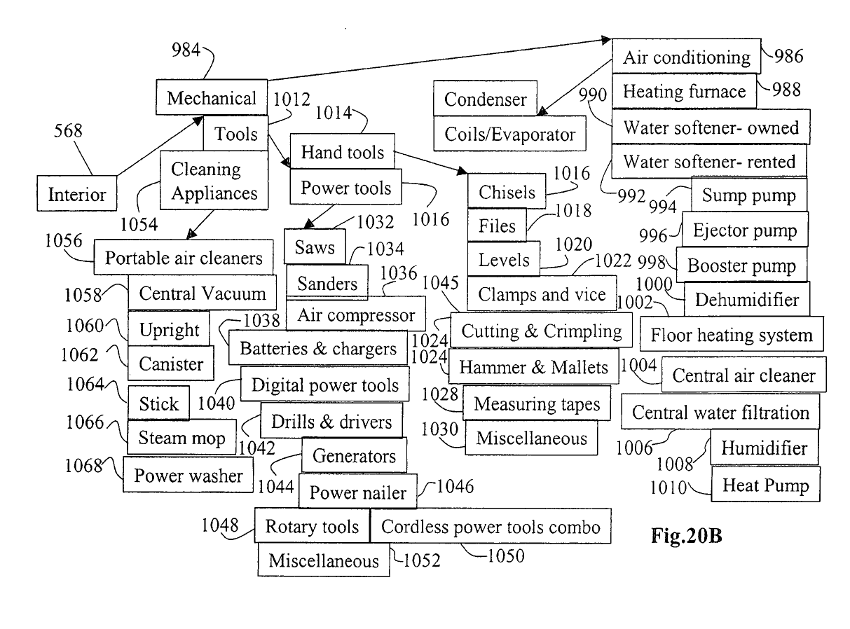

FIG. 20 shows exemplary sub-objects for common objects of Interior 568. For example, Object Fitness equipment 890 includes sub-objects Treadmill 898, Weight machine 900, Bicycle 902, AB Machine 904, and Other equipment 906. Sub-object Entertainment 908 includes sub-objects TV 910, Portable TV 912, VCR 914, DVD 916, Video game machine 918, Stereo systems 920, MP3 922, Radio 924, Satellite 926, Home theater box 928, Surround system 930, Receiver 932, Speaker 934, and Ipod 936. Of these, Video game m/c 918 may include sub-objects X-Box 938 or Playstation 940. Object communication 942 may include sub-objects Telephone 944, Broadband internet 946, Wireless phone 948, or Wireless broadband 950. Broadband Internet 948 includes sub-objects Satellite 952, DSL 954, and Cable 956.

Additionally, object Computer systems 958 may include sub-objects Computer 960, Laptop 962, PDA 964, Printer 966, and Scanner 968. Of these, PDA 964 may have sub-object peripherals 970. Both Computer 960 and Laptop 962 include sub-objects (common objects) Monitor 972, Mouse 974, Keyboard 976, Sound systems 978, Computer camera 980, and Peripherals 982.

Object Mechanical 984 may have various sub-objects including Air Conditioning 986, Heating furnace 988, Water softener-owned 990, Water softener-rented 992, Sump pump 994, Ejector pump 996, Booster pump 998, Dehumidifier 1000, Floor heating system 1002, Central air Cleaner 1004, Central water filtration 1006, Humidifier 1008, and Heat pump 1010. Object Tools 1012 includes sub-objects Hand Tools 1014 and Power Tools 1016. Hand Tools 1014, in turn, includes sub-objects Chisels 1016, Files 1018, Levels 1020, Clamps and vice 1022, Cutting and crimping 1024, Hammer and mallets 1026, Measuring tape 1028 and Miscellaneous 1030. Power Tools 1016, on the other hand, includes sub-objects Saws 1032, Sanders 1034, Air compressor 1036, Batteries & chargers 1038, Digital power tools 1040, Drills and drivers 1042, Generators 1044, Power nailer 1046, Rotary tools 1048, Cordless power tools combo 1050, and Miscellaneous 1052. Object Cleaning Appliances 1054 includes sub-objects Portable air cleaners 1056, Central vacuum 1058, Upright 1060, Canister 1062, Stick 1064, Steam mop 1066, and Power washer 1068.

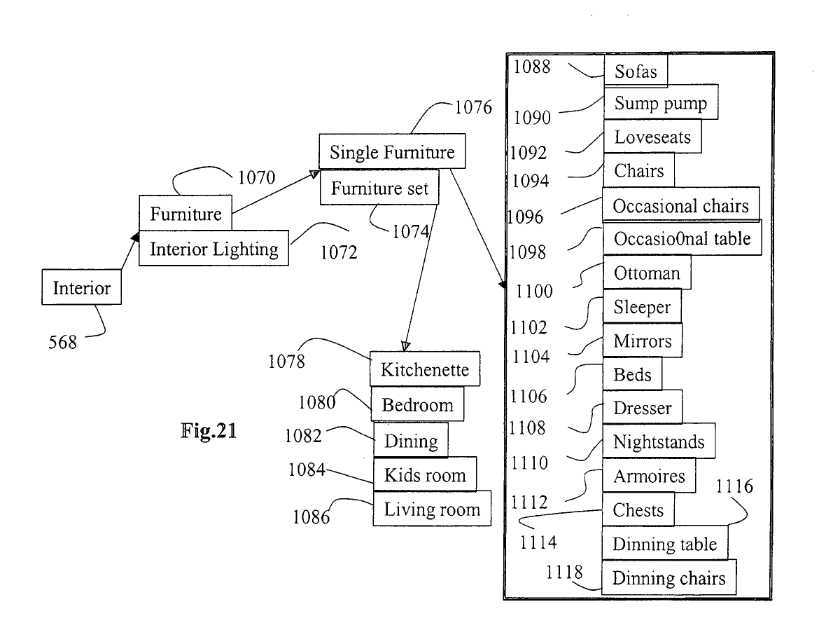

FIG. 21 shows other sub-objects of Interior, including Furniture 1070 and Interior Lighting 1072. Furniture 1070 includes sub-objects Furniture Set 1074 and Single furniture 1076. Furniture set 1074 in turn, includes sub-objects Kitchenette 1078, Bedroom 1080, Dining 1082, Kid's room 1084, and Living room 1086, while Single furniture 1076 includes sub-objects Sofas 1088, Sump pump 1090, Love seats 1092, Chairs 1094, Occasional chairs 1096, Occasional table 1098, Ottoman 1100, Sleeper 1102, Mirrors 1104, Beds 1106, Dressers 1108, Nightstands 1110, Armoires 1112, Chests 1114, Dining tables 1116, and Dining chairs 1118.

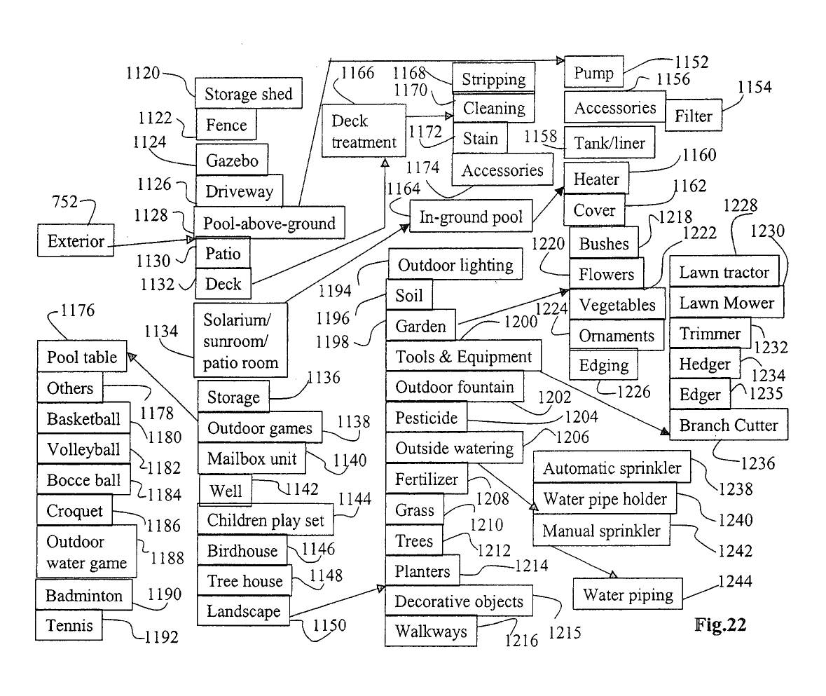

FIG. 22 shows sub-objects of object Exterior 752 including Storage shed 1120, Fence 1122, Gazebo 1124, Driveway 1126, Pool-above-ground 1128, Patio 1130, Deck 1132, Solarium/sunroom/patio room 1134, Storage 1136, Outdoor games 1138, Mailbox unit 1140, Well 1142, Children play set 1144, Birdhouse 1146, Tree house 1148, and Landscape 1150. Outdoor sub-objects of Pool-above-ground 1128 include Pump 1152, Filter 1154, Accessories 1156, Tank/liner 1158, Heater 1160, and Cover 1162, and Solarium/sunroom/patio room 1134 may have a sub-object In-Ground Pool 1164 including the same sub-objects as Pool-above-ground. Object Deck 1132 may include sub-object Deck treatment 1166, which may further include sub-objects Stripping 1168, Cleaning 1170, Stain 1172 and Accessories 1174. Sub-object Outdoor games 1138 include sub-objects Pool table 1176, Others 1178, Basketball 1180, Volleyball 1182, Bocce ball 1184, Croquet 1186, Outdoor water game 1188, Badminton 1190, and Tennis 1192.

Landscape 1150 sub-objects include Outdoor Lighting 1194, Soil 1196, Garden 1198, Tools and equipment 1200, Outdoor fountain 1201, Pesticide 1204, Outside watering 1206, Fertilizer 1208, Grass 1210, Trees 1212, Planters 1214, Decorative objects 1215, and Walkways 1216. Object Garden 1198 further includes sub-objects Bushes 1218, Flowers 1220, Vegetables 1222, Ornaments 1224 and Edging 1226. Tools and Equipment 1200 further includes sub-objects Lawn tractor 1228, Lawn mower 1230, Trimmer 1232, Hedger 1234, Edger 1235, and Branch cutter 1236. Object Outside watering 1206 includes sub-objects Automatic sprinkler 1238, Water pipe holder 1240, and Manual sprinkler 1242, which includes lower-level object Water piping 1244.

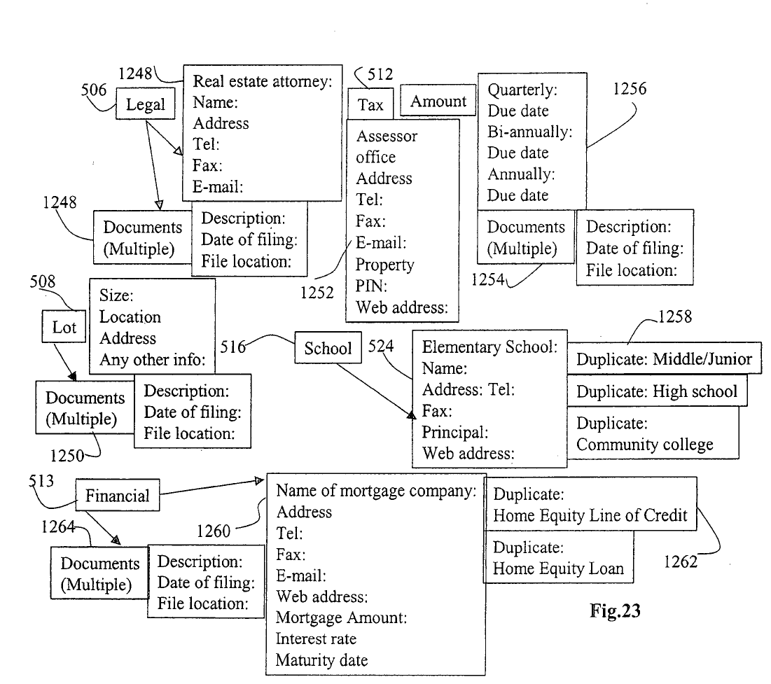

FIG. 23 illustrates use of other types of sub-objects that may be integrated into the object model 88. For example, Object Legal 506 may include sub-object Real estate attorney 1246 with attributes “address”, “telephone number”, “fax”, and “email”. Legal 506 may also include sub-objects for Documents 1248 (one or more) and object Documents may have attributes such as “Description”, “Date of filing”, and “File location”.

Object Lot 508 may have attributes such as “Size”, “Location”, “Address”, or “Other information”, and may include sub-objects Documents 1250 (one or more) have attributes such as described above. The Documents themselves (e.g., scanned copies) may be added to the object. Sub-object Tax 512 may have sub-objects Assessor office 1252, with attributes “Address”, “Telephone”, “Fax”, “Email”, “Property Personal Identification Num (PIN)”, and “Web Address”. Additionally, object Tax 512 may have one or more Document sub-objects 1254. Tax also may have sub-object Amount 1256 having attributes “Quarterly”, “Quarterly due date”, “Bi-annually”, “Bi-annual due date”, “Annually”, and “Annual due date”.

Some objects may be duplicates of other objects, having similar attributes. For example, object School 516 may include sub-object Elementary School 524 having attributes “Name”, “Address”, “Telephone”, “Fax”, “Principal”, and “Web address”. Duplicate sub-objects 1258 may be provided for Middle/Junior School, High School, or Community College. Similarly, object Financial 513 may include a sub-object Mortgage Company 1260 having attributes “Name”, “Address”, “Telephone”, “Fax”, “E-mail”, “Web address”, “Mortgage amount”, “Interest rate”, and “Maturity date”. Duplicate objects 1262 may be provided for Home equity line of credit, Home equity loan, etc. Financial may also be linked to one or more Documents 1264 sub-objects.

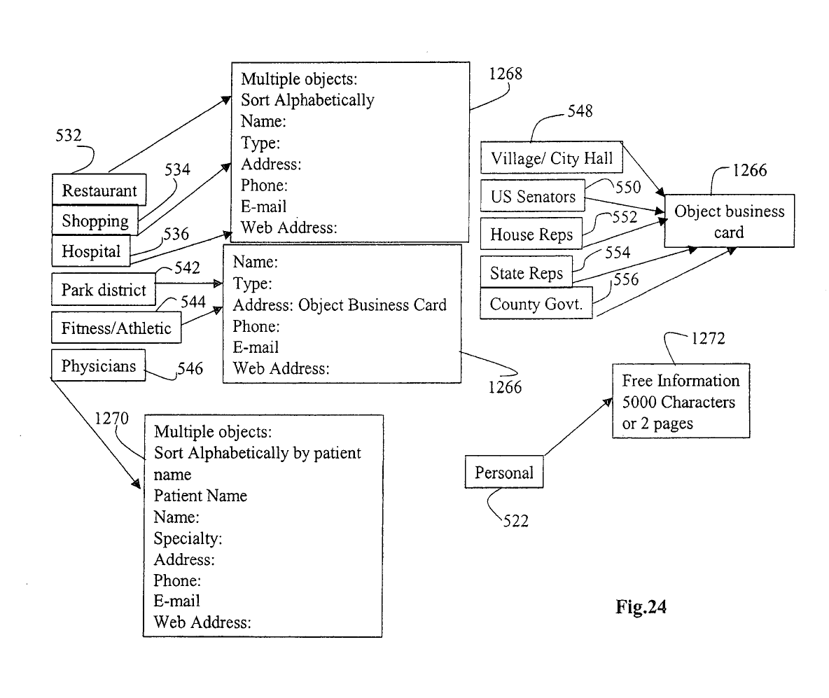

FIG. 24 illustrates Business Card objects that may be linked to one or more particular sub-objects. A Card object represents information similar to that of a business card or other card, such as name, address, fax, e-mail, web site, phone, etc. Object Business Card 1266, for example may include attributes such as “Name”, “Type”, “Address”, “Phone”, “E-mail”, and “Web address”, and possibly a scanned copy of a digitized copy of the business card itself. The Business Card object 1266 may be linked to, for example, objects Park district 542, Fitness/athletic 544, Village/city hall 548, U.S. Senators 550, House representatives 552, State representatives 554, and County government 556.

Objects may include multiple sub-objects for individual instances. Such sub-objects may be sorted for example, alphabetically by the object themselves or by other things. For example, sub-objects Restaurants 532, Shopping 534 and Hospital 538 may have a multiple sub-object 1268 for a particular business having attributes “Name”, “Type”, “Address”, “Phone”, “Email”, and “Web Address”. Object Physicians 546 includes sub-objects for particular patients, sorted alphabetically by patient name. Patient objects 1270 may include attributes “Patient name”, “Physician name”, “Specialty”, “Address”, “Phone”, “E-mail”, and “Web address”. Object Personal 522 may have a sub-object 1272 with free information (such as a certain number of characters or pages for free input of information).

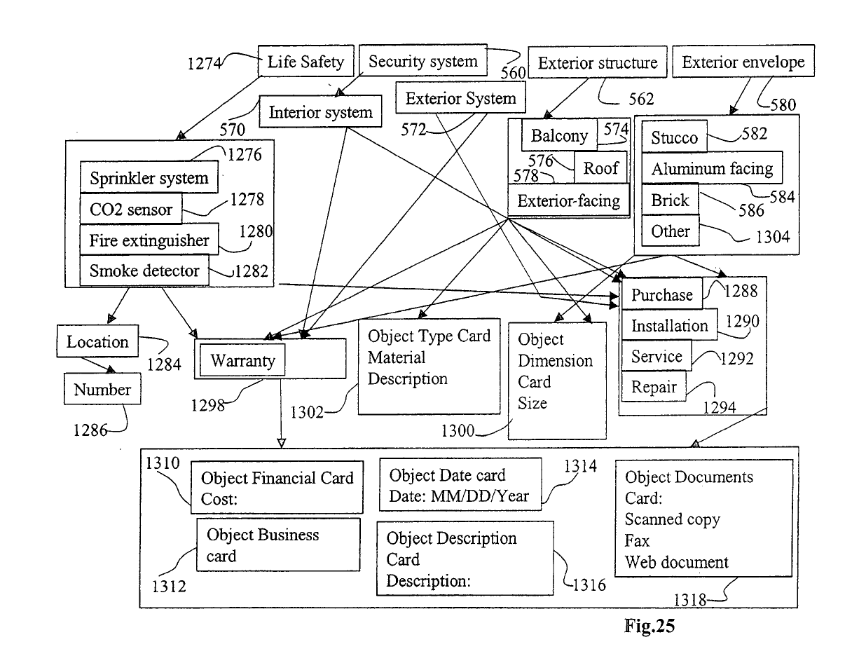

FIG. 25 illustrates a partial object model that incorporates other card objects. For example, object Life safety 1274 may include sub-objects Sprinkler system 1276, CO₂ sensor 1278, Fire extinguisher 1280, and Smoke detector 1282. Each of these sub-objects may in turn have sub-object Location 1284, which itself has a sub-object Number 1286. Further, sub-objects Purchase 1288, Installation 1290, Service 1292, and Repair 1294 may be sub-objects of the above objects as well as for parent objects Interior system 570 and Exterior system 572 (which are sub-objects of Security System 560). Object Warranty 1298 may also be a sub-object of Interior system 570, Exterior system 572 or other objects. Object exterior structure 562 may include sub-objects Balcony 574, Roof 570 and Exterior Facing 578, and these may include sub-object Dimension Card 1300. Object Dimension card 1300 includes attribute “Size”. Similarly, objects Balcony 574, Roof 576 and Exterior facing 578 may include sub-object Type card 1302, including attributes “Material” and “Description”. Object Exterior envelope 580 may have sub-objects Stucco 582, Aluminum facing 584, Brick 586 and Other 1304, and these may also include sub-object Dimension Card 1300. Sub-objects Purchase 1288, Installation 1290, Service 1292, Repair 1294, and Warranty 1298 may have one or more of sub-objects Financial Card 1310, Business Card 1312, Date Card 1314, Description Card 1316, and Documents Card 1318. Documents Card 1318, for example, may include attributes such as “Scanned Copy”, “Fax”, or “Web document”. Additionally, object Date card 1314 may include an attribute for the date, and Object Description card 1316 may include an attribute for a description. It is also contemplated that data represented by one or more of these sub-objects may instead be represented by attributes of an existing object. For example, objects Purchase 1288, Installation 1290, Service 1292, and Repair 1294 may instead be represented by attributes of their respective higher-level objects.

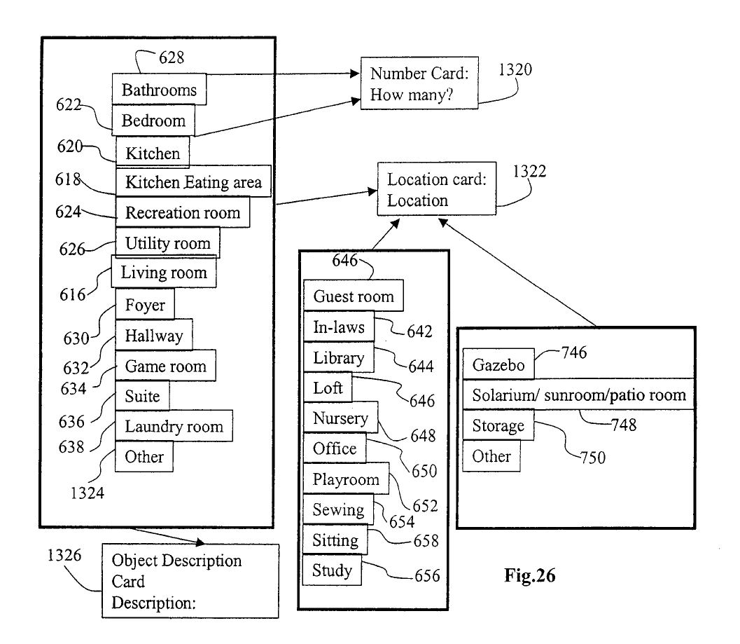

Further examples of card objects are shown in FIG. 26. For example, sub-objects representing rooms may include a sub-object Number card 1320 with attribute “How many”. Similarly, the room sub-objects may include a sub-object Location card 1322 with an attribute “Location”. Location cards 1322 provide a template for common sub-objects of various objects. Room sub-object Other 1324 may include a Description card 1326 with an attribute “Description”.

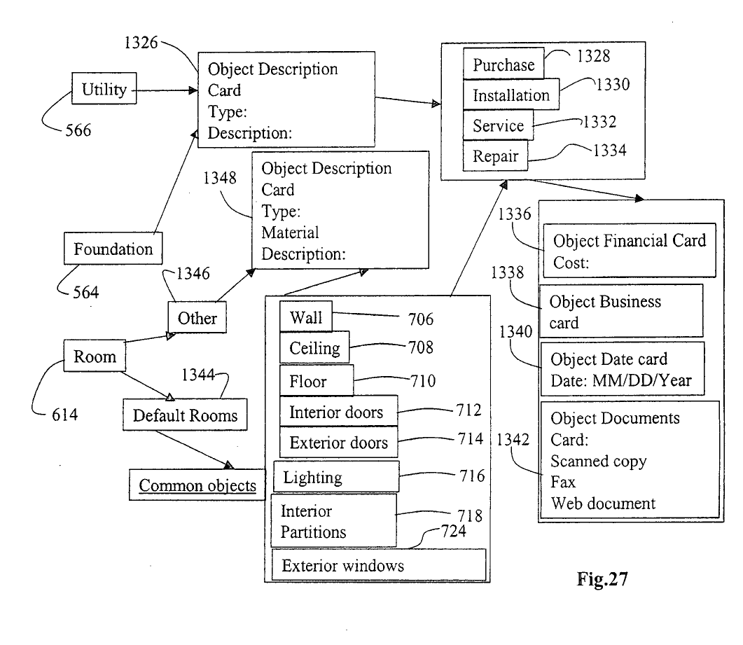

FIG. 27 illustrates other examples incorporating card objects into the object model. In the example shown, both objects Utility 566 and Foundation 564 include object Description card 1326, with attributes “Type” and “Description”. The Description card object 1326 itself includes sub-objects Purchase 1328, Installation 1330, Service 1332 and Repair 1334, and these sub-objects in turn include sub-objects Financial card 1336, Business card 1338, Date card 1340, and/or Documents card 1342.

As another example, object Room 614 may include sub-objects Default Rooms 1344 and Other 1346. Sub-object Default rooms 1344 provides a default group of potential sub-objects for a particular room for more efficient creation of new objects for often-used components of a room. Default Rooms 1344 may include common objects Wall 706, Ceiling 708, Floor 710, Interior doors 712, Exterior doors 714, Interior partitions 716, Lighting 718, and Exterior windows 724. These common objects as well as object Other 1346 may in turn include sub-object Description Card 1348, having attributes “Type”, “Material”, and “Description”. The common objects may also include sub-objects Purchase 1328, Installation 1330, Service 1332, and Repairs 1334 as described above.

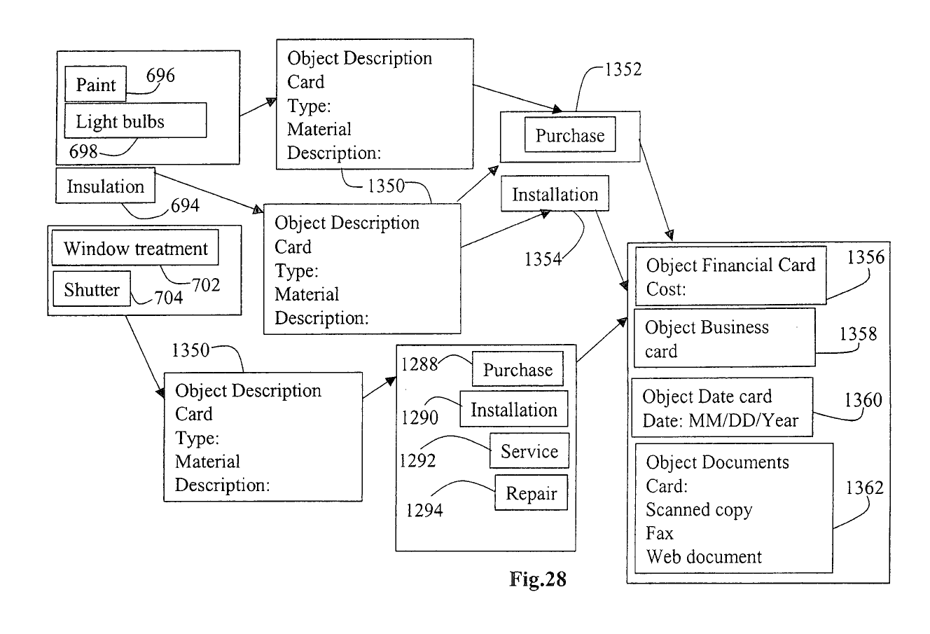

Referring now to FIG. 28, showing additional uses of card objects, objects Paint 696, Light bulbs 698, Insulation 694, Window treatment 702, and Shutter 704 each include a sub-object Description card 1350, including attributes such as “Type”, “Material”, and “Description”. Description card 1350 may itself have sub-objects such as Purchase 1352 and/or Installation 1354, and these sub-objects in turn may include sub-objects Financial card 1356, Business card 1358, Date card 1360, and/or Documents card 1362.

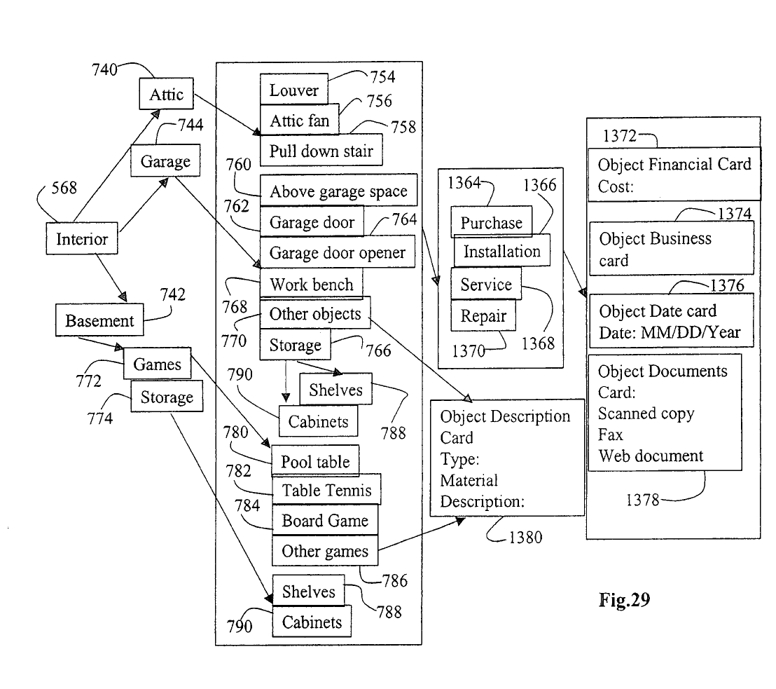

As another example, FIG. 29 includes sub-objects of Interior 568, as previously shown in FIG. 18. Each of these sub-objects for example may further include sub-objects Purchase 1364, Installation 1366, Service 1368, or Repair 1370. Purchase, Installation, Service and Repair may themselves include sub-objects Financial card 1372, Business card 1374, Date card 1376, and/or Documents card 1378. Sub-objects Other objects 770 and Other games 786 include sub-object Description Card 1380 for describing the particular garage item or game.

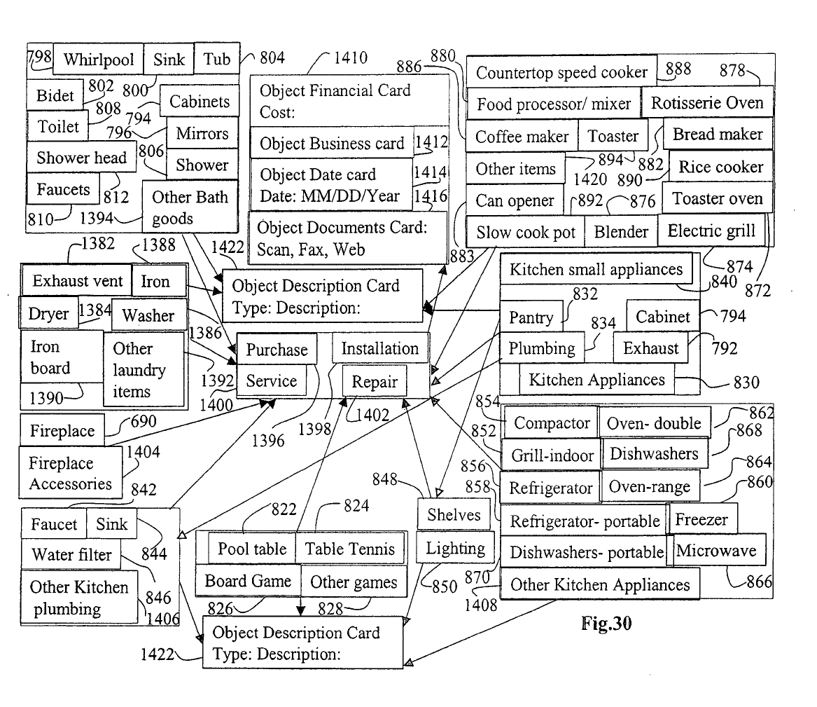

Referring now to FIG. 30, linking to several types of objects is illustrated. Objects Exhaust vent 1382, Dryer 1382, Washer 1386, Iron 1388, Iron board 1390 and other laundry room items 1392, as well as objects Cabinets 794, Mirrors 796, Whirlpool 798, Sink 800, Bidet 802, Tub 8004, Shower 806, Toilet 808, Faucets 810, Shower head 812 and Other bath goods 1394 include sub-objects Purchase 1396, Installation 1398, Service 1400, and Repair 1402. Similarly, objects Fireplace 690 and Fireplace accessories 1404 are linked to these sub-objects. Similarly, Objects Pool Table 822, Table Tennis 824, Board Game 826, and Other games 828 have these sub-objects. Objects Faucets 842, Sink 844, Water filter, and Other kitchen plumbing 1406, sub-objects of Plumbing 834, include the Purchase 1396, Installation 1398, Service 1400, and Repair 1402 sub-objects. Further, objects Grill-indoor 852, Compactor 854, Refrigerator 856, Refrigerator-portable 858, Freezer 860, Oven-double 862, Oven-range 864, Microwave 866, Dishwashers 868, Dishwashers-portable 870, and Other kitchen appliances 1408, are linked to these sub-objects to indirectly link object Kitchen Appliances 830. Sub-objects Exhaust 792 and Cabinet 794 are linked to Purchase 1376, Installation 1398, Service 1400, and Repair 1402, while Pantry 832 is linked there via sub-objects Shelves 848 and Lighting 850. Object Plumbing 834 is linked to these sub-objects as stated above. Similarly, Kitchen Small Appliances 840, including sub-objects Toaster Oven 872, Blender 876, Countertop speed cooker 888, Electric grill 874, Rotisserie oven 878, Coffee maker 886, Food processor/mixer 880, Bread maker 882, Can opener 884, Slow cook pot 892, Toaster 894, Rice Cooker 890, and Other items may have similar sub-objects. Sub-objects Purchase 1396, Installation 1398, Service 1400 and Repair 1402 may themselves have sub-objects Financial Card 1410, Business Card 1412, Date Card 1414, and/or Documents Card 1416. Objects Other laundry room items 1392, Other bath goods 1394, Other kitchen plumbing 1406, Other kitchen appliances 1408, and Other items 1420 include sub-object Description card 1422 for supplying additional information about these items.

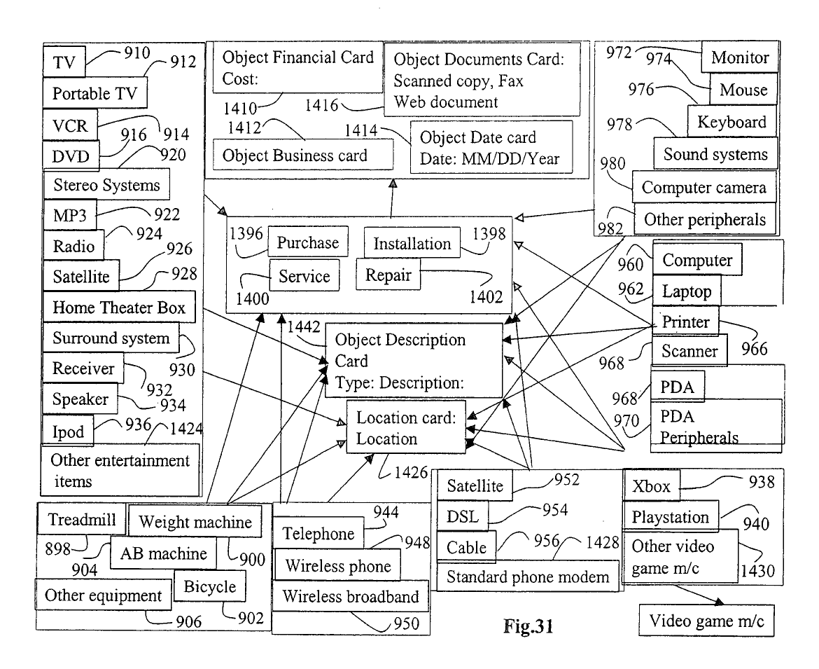

FIG. 31 shows similar integration of card objects with sub-objects of Interior 568. For example, objects TV 910, Portable TV 912, VCR 914, DVD 916, Stereo systems 920, MP3 922, Radio 924, Satellite 926, Home theater box 928, Surround system 930, Receiver 932, Speaker 934, Ipod 936, and Other entertainment Items 1424 include sub-objects Purchase 1396, Installation 1398, Service 1400, and Repair 1402, as well as sub-object Location Card 1426. Similarly, objects Treadmill 898, Weight Machine 900, Bicycle 902, AB machine 904, and Other equipment 906; Telephone 944, Wireless phone 948, and Wireless broadband 950; Satellite 952, DSL 954, Cable 956, and Standard phone modem 1428; Xbox 938, Playstation 940, and Other video game m/c 1430; Monitor 972, Mouse 974, Keyboard 976, Sound systems 978, Computer camera 980, and Other peripherals 982; PDA 964; and PDA peripherals 970 have the Purchase 1396, Installation 1398, Service 1400, and Repair 1402 sub-objects. Objects Computer 960 and Laptop 962 further include sub-object Location card 1440. Objects Other equipment 906, PDA peripherals 970, and Other video game m/c 1430 also include sub-object Description card 1442.

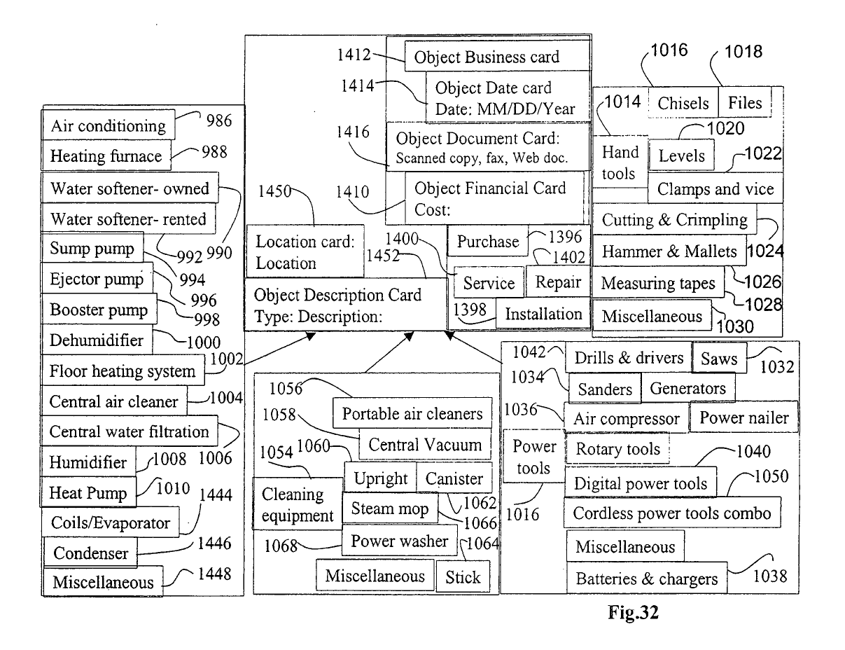

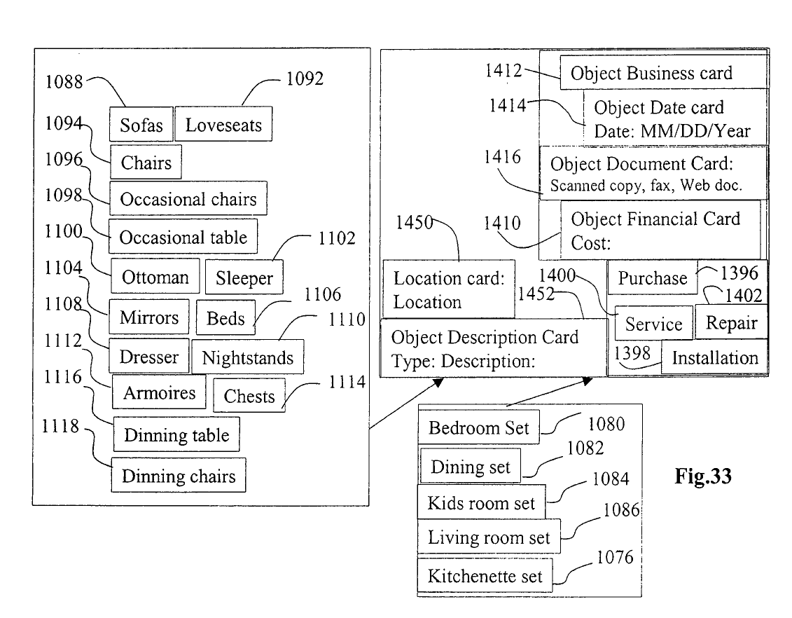

As shown in FIG. 32, Mechanical 984 sub-objects Air Conditioning 986, Heating Furnace 988, Water softener-owned 990, Water-softener-rented 992, Sump pump 994, Ejector pump 996, Booster pump 998, Dehumidifier 1000, Floor heating system 1002, Central air cleaner 1004, Central water filtration 1006, Humidifier 1008, Heat pump 1010, Coils/Evaporator 1444, Condenser 1446, and Miscellaneous 1448 include sub-objects Financial card 1410, Date card 1414, Business card 1412, Documents card 1416, Location card 1450, Description card 1452, Purchase 1396, Installation 1398, Service 1400, and Repair 1402. These sub-objects are also included for cleaning equipment objects Portable Air Cleaners 1056, Central Vacuum 1058, Upright 1060, Canister 1062, Stick 1064, Steam mop 1066, Power Washer 1068, and Miscellaneous; Power Tools 1016 sub-objects Drills and drivers 1042, Saws 1032, Sanders 1034, Generators 1044, Power nailer 1046, Air compressor 1036, Rotary tools 1048, Batteries & Chargers 1038, Digital power tools 1040, Cordless power tools combo 1050, and Miscellaneous; and Hand Tools 1014 sub-objects Chisels 1010, Files 1018, Levels 1020, Clamps and vice 1022, Cutting & crimping 1024, Hammer & mallets 1026, Measuring tapes 1028, and Miscellaneous 1030. Similar sub-objects are included for Furniture 1070 sub-objects Sofas 1088, Loveseats 1092, Chairs 1094, Occasional chairs 1096, Occasional table 1098, Ottoman 1100, Sleeper 1102, Mirrors 1104, Beds 1106, Dresser 1108, Nightstands 1110, Armoires 1112, Chests 1114, Dining table 1116, Dining chairs 1118, Bedroom set 1080, Dining set 1082, Kids room set 1084, Living room set 1086, and Kitchenette Set 1078, as shown in FIG. 33.

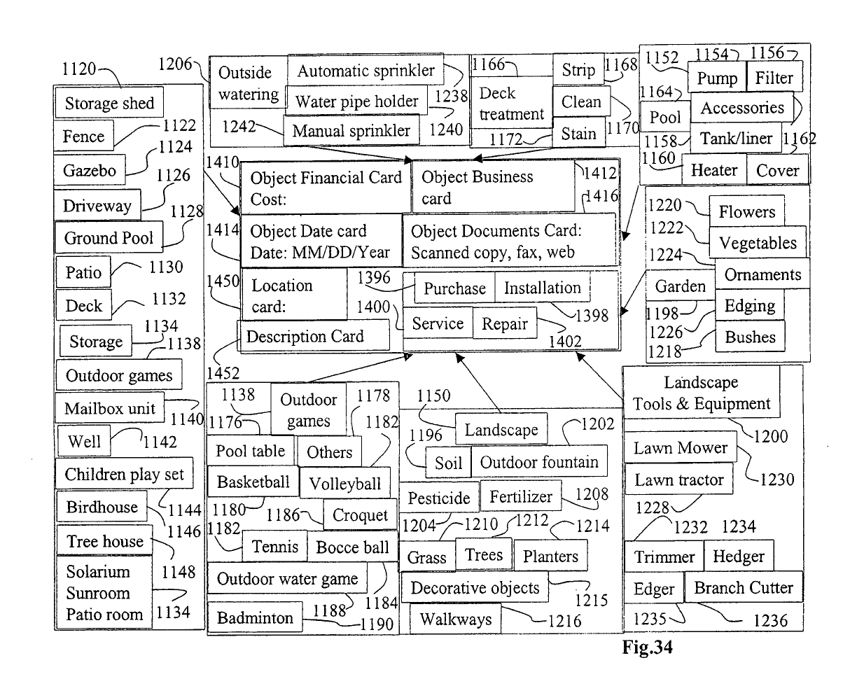

Further, similar to that shown in FIG. 32-33, FIG. 34 shows other objects that include the Financial card 1410, Date card 1414, Location card 1450, Description card 1452, Business card 1412, Documents card 1416, Purchase 1396, Installation 1398, Service 1400, and Repair 1400 sub-objects. These objects include: Exterior 752 sub-objects Storage shed 1120, Fence 1122, Gazebo 1124, Driveway 1126, Pool-above-ground 1128, Patio 1130, Deck 1132, Storage 1136, Outdoor games 1138, Mailbox unit 1140, Well 1142, Children play set 1144, Birdhouse 1146, Tree house 1148, Solarium Sunroom and Patio Room 1134; Outside Watering 1206 sub-objects Automatic sprinkler 1138, Water pipe holder 1240, and Manual sprinkler 1242; Deck treatment 1166 sub-objects Stripping 1168, Cleaning 1170, and Stain 1172; In-ground pool 1164 sub-objects Pump 1152, Filter 1154, Accessories 1156, Tank/liner 1158, Heater 1160, and Cover 1162; Garden 1198 sub-objects Bushes 1218, Flowers 1220, Vegetables 1222, Ornaments 1224, and Edging 1226; Landscape Tools & Equipment 1200 sub-objects Lawn tractor 1228, Lawn mower 1230, Trimmer 1232, Hedger 1234, Edger 1235, and Branch Cutter 1236; Landscape 1150 sub-objects Soil 1198, Outdoor Fountain 1202, Pesticide 1204, Fertilizer 1208, Grass 1210, Trees 1212, Planters 1214, Decorative Objects 1215, and Walkways 1216; and Outdoor Games 1138 sub-objects Pool Table 1176, Others 1178 (which may also link to a Description card object 1452), Basketball 1180, Volleyball 1182, Bocce ball 1184, Croquet 1186, Outdoor water game 1188, Badminton 1190, and Tennis 1192.

A home management system 40 has been pictured and described herein having many uses and benefits. In addition to using the system 40, other applications are possible, including automobiles, people, etc., which may be implemented using object modeling. The preferred home management system 40 potentially offers substantial business value for areas such as new construction, existing home sales, and potentially opens new channels of communication between outside parties and users (homeowners) for business transactions.

While various embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the present invention are set forth in the appended claims.

1. A method for collecting data relating to a household, the method comprising:
providing an object model including a plurality of objects representing items relating to the household;
receiving a data item including information relating to a section of the household;
incorporating the data item into the object model.

2. The method of claim 1 wherein said receiving comprises receiving the data item over a network.

3. The method of claim 2 wherein the network comprises the Internet.

4. The method of claim 1 wherein said objects are pre-linked objects, and wherein said incorporating comprises modifying one or more of the pre-linked objects.

5. The method of claim 1 wherein said incorporating comprises adding a new object to the plurality of objects.

6. The method of claim 1 wherein the object model is incorporated into a database.

7. The method of claim 1 further comprising:
retrieving one or more of the plurality of objects;
analyzing the retrieved objects.

8. A method of managing information relating to a household, the method comprising:
receiving data relating to the household;
analyzing the received data to provide one or more objects;
incorporating the one or more objects into an object model.

9. The method of claim 8 wherein the received data relates to a home itself and/or items within the home.

10. The method of claim 8 wherein said receiving occurs after equipment or a component is purchased, replaced, repaired, maintained, or updated.

11. The method of claim 8 wherein said receiving comprises receiving is via a network interface.

12. A management system for items relating to a home, the system comprising:
an object model-based information platform including linked objects representing the items;
a model-based database for storing the objects according to said object model-based information platform;
an input data platform for providing additions or modifications to the stored objects;
an information processing platform for processing the stored objects in said model-based database;
an applications management platform for controlling processing performed by said information processing platform.

13. The management system of claim 12 further comprising:
a connection between the model-based database and an outside party for providing input information.

14. The management system of claim 13 further comprising:
a parser for receiving input information, analyzing the information, and incorporating the analyzed information into the object model.

15. The management system of claim 14 wherein said parser analyzes the information by retrieving at least one of objects and attributes from the information, and incorporates the information by adding objects to said model-based database or modifying objects in said model-based database.

16. The management system of claim 11 wherein said object model-based information platform comprises pre-linked objects.

17. The management system of claim 11 wherein said object model-based information platform comprises objects linked by a user.

18. The management system of claim 11 wherein the objects comprise common objects which are children of more than one object, and custom sub-objects, which are sub-objects of only one object.

19. The management system of claim 18 wherein the common sub-objects are separately selectable by the user for adding to said object model-based information platform and for adding or modifying attributes of the common objects.

20. The management system of claim 11 wherein said input data platform comprises at least one of a menu-driven interface and a graphical interface.

21. The management system of claim 11 wherein said input data platform comprises a graphical interface including a graphical representation of the home, the graphical interface including a plurality of graphical objects linked to objects in said object model-based information platform.
